(19) United States
(12) Patent Application Publication
(10) Pub. No.: US 2018/0088978 A1
(43) Pub. Date: Mar. 29, 2018

(54) Techniques for Input/Output Access to Memory or Storage by a Virtual Machine or Container

(71) Applicant: Intel Corporation, Santa Clara, CA (US)

(72) Inventors: Yadong Li, Portland, OR (US); David Noeldner, Fort Collins, CO (US); Bryan E. Veal, Beaverton, OR (US); Amber D. Huffman, Banks, OR (US); Frank T. Hady, Portland, OR (US)

(73) Assignee: Intel Corporation, Santa Clara, CA (US)

(21) Appl. No.: 15/280,294

(22) Filed: Sep. 29, 2016

(51) Int. Cl. G06F 9/455; G06F 13/28

(52) U.S. Cl. CPC G06F 9/45558; G06F 2009/45583; G06F 2009/45579; G06F 13/28

(57) ABSTRACT

Examples include techniques for input/output (I/O) access to physical memory or storage by a virtual machine (VM) or a container. Example techniques include use of a queue pair maintained at a controller for I/O access to the physical memory or storage. The queue pair including a submission queue and a completion queue. An assignment of a process address space identifier (PASID) to the queue pair facilitates I/O access to the physical memory or storage for a given VM or container.

### TECHNICAL FIELD

Examples described herein are generally related to access to memory or storage at a host computing platform in a virtualization computing environment.

### BACKGROUND

As virtualization computing environments become more and more an important technology in public cloud systems, a next wave of innovations may focus on improving efficiency of data center infrastructure via adoption of high density virtual machine (VM) or containers technologies. A container running inside a lightweight and secure VM may provide for high density configurations for a host computing platform to host multiple tenants as part of a public cloud system. In some examples, a hypervisor or virtual machine manager (VMM) implemented by an operating system (OS) of the host computing platform may allocate memory or storage resources to VMs and/or containers to enable input/output (I/O) access to these memory or storage devices by the VMs and/or containers.

### BRIEF DESCRIPTION OF THE DRAWINGS

FIG. 1 illustrates an example host computing platform.

FIG. 2 illustrates an example first system.

FIG. 3 illustrates an example second system.

FIG. 4 illustrates an example first process.

FIG. 5 illustrates an example second process.

FIG. 6 illustrates an example block diagram for a first apparatus.

FIG. 7 illustrates an example of a first logic flow.

FIG. 8 illustrates an example of a first storage medium.

FIG. 9 illustrates an example block diagram for a second apparatus.

FIG. 10 illustrates an example of a second logic flow.

FIG. 11 illustrates an example of a second storage medium.

FIG. 12 illustrates an example block diagram for a third apparatus.

FIG. 13 illustrates an example of a third logic flow.

FIG. 14 illustrates an example of a third storage medium.

FIG. 15 illustrates an example computing platform.

FIG. 16 illustrates an example memory/storage device.

### DETAILED DESCRIPTION

As contemplated in the present disclosure, a hypervisor or VMM implemented by an OS of a host computing platform may allocate memory or storage resources to VMs and/or containers to enable I/O access to these memory or storage devices by the VMs and/or containers. In some examples, for access to storage devices such as solid state drives (SSDs) or hard disk drives (HDDs), several technologies have been designed and used by SSDs to support I/O access for VMs and/or containers. These technologies may include, but not are limited to, technologies for an input/output memory management unit (IOMMU) or a single root input/output virtualization (SR-IOV). In some examples, I/O access using IOMMU and/or SR-IOV technologies may be facilitated via use of isolated virtual functions (VFs) at a memory or storage device such as an SSD. Each isolated VF may be directly assigned to a given VM or container by a hypervisor/VMM arranged to manage VMs or containers hosted by the host computing platform. The I/O access facilitated by the isolated VFs may be routed through a controller for a memory or storage device. The controller may be arranged as an endpoint that may utilize communication protocols and/or interfaces according to the Peripheral Component Interconnect (PCI) Express Base Specification, revision 3.1a, published in December 2015 (“PCI Express specification” or “PCIe specification”). The controller for the memory or storage device, for example, may be a controller for an SSD that includes one or more types of non-volatile and/or volatile memory. The controller may also be arranged to operate according to one or more types of memory or storage access technologies. The one or more memory or storage access technologies may include, but are not limited to, the Non-Volatile Memory Express (NVMe) Specification, revision 1.2a, published in October 2015 (“NVM Express specification” or “NVMe specification”) or the Serial Attached SCSI (SAS) Specification, revision 3.0, published in November 2013 (“SAS-3 specification”).

According to some examples, use of isolated VFs at a controller for a memory or storage device may consume a large amount of computing resources at the controller. For example, each VF may require around 10,000 logic gates at the controller. As densities for VMs and/or containers increase (e.g., more than 1,000 containers) on a given host computing platform, the relatively large number of logic gates needed per VF may be difficult and expensive to provide at a controller for a memory or storage device. Possibly millions of logic gates at a memory or storage device to support use of isolated VFs for high density VM/container environments may be prohibitively expensive for most controllers. Further, in some examples, VFs typically use 8-bit PCIe device request identifiers (IDs). These 8-bit PCIe device request IDs limit a number of VFs at a memory or storage device to a total of 256 VFs. Hence, both the relatively large number of logic gates per VF and a limited number of 8-bit PCIe device request IDs for VFs may limit scalability for providing I/O access to memory or storage devices via use of isolated VFs at controllers for these memory or storage devices. It is with respect to these challenges that the examples described herein are needed.

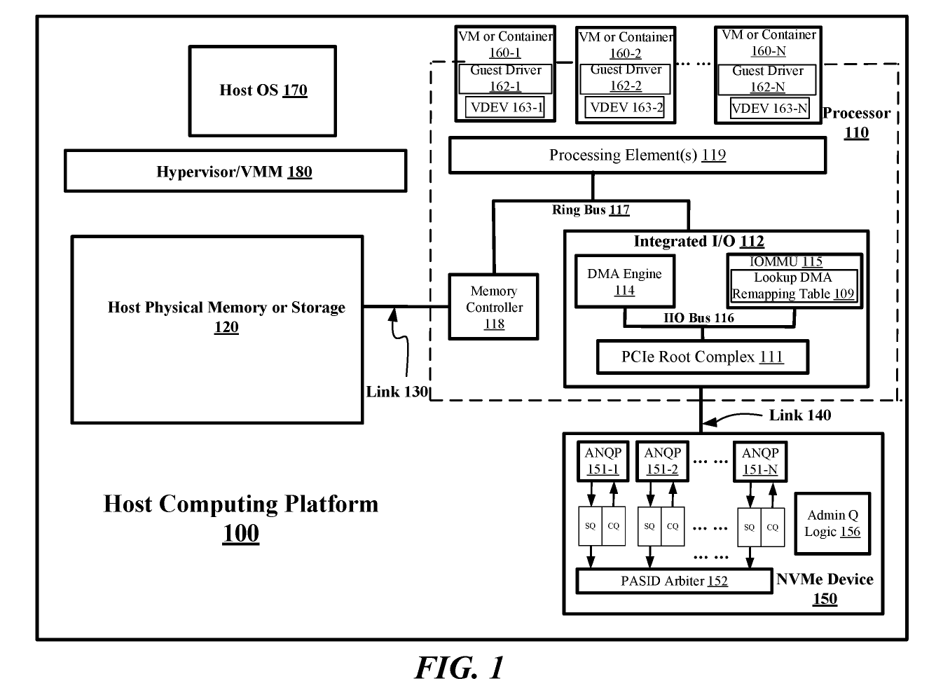

FIG. 1 illustrates an example system 100. In some examples, as shown in FIG. 1, host computing platform 100 includes, a host operating system (OS) 170, a hypervisor/VMM 180, a processor 110 coupled with a host physical memory or storage 120 and an NVMe device 150 via respective links 130 and 140. Processor 100 may be capable of supporting both host OS 170 and hypervisor/VMM 180. For these examples, NVMe device 150 may serve as a controller for access to host physical memory or storage 120 and may include logic and/or features arranged to operate according to the PCIe and NVMe specifications.

According to some examples, as shown in FIG. 1, processor 100 may also be capable of supporting a plurality of VMs or containers (including VMs or containers 160-1 to 160-N, where “N” as used for VMs or containers 160-1 to 160-N and other elements of host computing platform refers to any whole positive integer greater than 2.

In some examples, host physical memory or storage 120, processor 110 and NVMe device 150 may be physical elements arranged as part of a virtualization environment of a public cloud system that supports virtual elements such as VMs or containers 160-1 to 160-N. Read/write access to host physical memory or storage 120 for VMs or containers 160-1 to 160-N may be facilitated by assignable queue pairs such as assignable NVMe queue pairs (ANQPs) 151-1 to 151-N. As shown in FIG. 1, ANQPs 151-1 to 151-N may be located at a physical I/O controller or device such as NVMe device 150. In some examples, VMs or containers 160-1 to 160-N may be directly assigned to respective ANQPs 151-1 to 151-N to support SR-IOV and support use of an IOMMU such as IOMMU 115 for read/write access to host physical memory or storage 120. As described in more detail below, ANQPs 151-1 to 151-N may be directly assigned to respective VMs or containers 160-1 to 160-N by a hypervisor such as hypervisor/VMM 180.

According to some examples, ANQPs 151-1 to 151-N may be assigned to virtual devices (VDEVs) 163-1 to 163-N that may be communicatively coupled with and/or controlled by respective guest drivers 162-1 to 162-N executed by respective VMs or containers 160-1 to 160-N. The assignment of ANQPs 151-1 to 151-N to VDEVs 163-1 to 163-N may allow respective VMs or containers 160-1 to 160-N to directly interact with these assigned ANQPs. In some examples, direct interaction may be through a PCIe root complex 111 included in an integrated I/O 112 for processor 110 that may couple with NVMe device 150 via link 140. According to some examples, PCIe root complex 111 and NVMe device 150 may utilize communication protocols and interfaces according to the PCIe specification to enable VDEVs 163-1 to 163-N of guest drivers 162-1 to 162-N to directly interact with ANQPs 151-1 to 151-N via link 140. PCIe root complex 111 and NVMe device 150 may also exchange read or write requests/completions via a PCIe compliant link 140. In some examples, NVMe device 150 may also be arranged to operate according to the NVMe specification and may serve as a controller for accessing at least portions of host physical memory or storage 120.

In some examples, as shown in FIG. 1, processor 110 may include processing element(s) 119. Processing element(s) 119 may include one or more processing cores. In one example, each VM arranged to support one or more VMs or containers 160-1 to 160-N may be supported by separate processing cores or may be supported by combination of processing cores. Processor 110 may also include a ring bus 117 arranged to facilitate communications between processing element(s) 119, memory controller 118 and elements of integrated I/O 112 to further the support of VMs or containers 160-1 to 160-N. In some examples, memory controller 118 may manage read or write requests to host physical memory or storage 120 via link 130 in support of VMs or containers 160-1 to 160-N. Meanwhile, integrated I/O 112 may facilitate I/O communications with I/O devices such as NVMe device 150 via link 140 (e.g., using PCIe or NVMe protocols) in support of VMs or containers 160-1 to 160-N.

According to some examples, as shown in FIG. 1, in addition to the above-mentioned PCIe root complex 111, integrated I/O 112 may also include a direct memory access (DMA) engine 114 and an IOMMU 115. These elements of integrated I/O 112 may be coupled via an integrated I/O (IIO) bus 116. As described more below, these elements of integrated I/O 112 may include logic and/or features capable of facilitating efficient I/O access to host physical memory or storage 120 by VMs or containers supported by processor 110 such as VMs or containers 160-1 to 160-2. One such feature is a Lookup DMA remapping table 109 maintained at IOMMU 115 that may be utilized to translate guest physical addresses (GPAs) used by VMs or containers to host physical addresses (HPAs) used by DMA engine 114 to write or read data to/from host physical memory or storage 120.

In some examples, as described more below, elements of host computing platform 100 may be arranged to support use of a process address space identifier (PASID) to facilitate scalable I/O access to host physical memory or storage 120 by virtualized elements such as VMs or containers 160-1 to 160-N. For these examples, use of a PASID may include use of a 20-bit PASID prefix header. The 20-bit PASID prefix header (hereinafter referred to as “PASID”) may be part of a PCIe read or write transaction layer packet (TLP) (e.g., transmitted or received via link 140). Elements of host computing platform 100 such as PCIe root complex 111 and IOMMU 115 may be arranged to utilize a PASID included in a PCIe read or write TLP. For example, IOMMU 115 may use a given PASID along with lookup DMA remapping table 109 in order to translate a guest physical address (GPA) received in a PCIe read or write TLP to a host physical addresses (HPA). The PASID included in the PCIe read or write TLP may be associated with a specific VM or container from among VM or containers 160-1 to 160-N that may be directly assigned to a specific ANQP from among ANQPs 151-1 to 151-N by logic and/or features of host computing platform 100 such as hypervisor/VMM 180.

According to some examples, use of 20-bit PASIDs may replace use of 8-bit VF-based request IDs. Use of a 20-bit PASIDs substantially increases a number of uniquely identified and separately assigned ANQPs to VMs or containers compared to being limited to 8-bit VF-based request IDs. Also, as mentioned previously, each VF at an I/O controller or device such as NVMe device 150 may require thousands of logic gates. Whereas, ANQPs such as ANQPs 151-1 to 151-N may require substantially less computing resources such as a submission queue (SQ) and a completion queue (CQ) per ANQP and associated control logic at NVMe device 150. The SQs ANQPs 151-1 to 151-N may temporarily store read/write requests received from respective directly assigned VMs or containers 160-1 to 160-N. The CQs at ANQPs 151-1 to 151-N may temporarily store completion indications of fulfilled read/write requests made by respective directly assigned VMs or containers 160-1 to 160-N.

According to some examples, as described more below, NVMe device 150 may include a PASID arbiter 152 and an Admin Q logic 156. PASID arbiter 152 and Admin Q logic 156 may be associated control logic to support use of ANQPs 151-1 to 151-N to facilitate I/O or read/write access to host physical memory or storage 120 by respective VMs or containers 160-1 to 160-N. In some examples, PASID arbiter 152 and Admin Q logic 156 may be arranged to support arbitration between individual or groups of ANQPs having read/write requests in their respective SQs. The arbitration may be based, at least in part, on quality of service (QoS) and/or bandwidth control settings or requirements. The QoS and/or bandwidth control requirements may be driven by, for example, service level agreements (SLAs) with one or more tenants or customers that may be separately associated with each VM and/or container from among VMs or containers 160-1 to 160-N.

In some examples, each ANQP from among ANQPs 151-1 to 151-N may be assigned or attached with one or more namespaces. For these examples, the one or more namespaces may be similar to a small system computer interface (SCSI) logical unit number (LUN) that may be presented as a disk drive to elements of host computing platform 100 such as OS 170. The SCSI LUN may be arranged according to guidance established by the T10 Technical Committee on SCSI Storage Interfaces of the International Committee on Information Technology Standards (INCITS), operating under the American National Standards Institute (ANSI), see http://www.t10org/. Admin Q logic 156 may include logic and/or features to provide namespace access control for security isolation of VMs or containers 160-1 to 160-N having respective VDEVs 163-1 to 163-N respectively assigned to ANQPs 151-1 to 151-N. The namespace access control may include read only access or read/write access for each assigned or attached namespace. The logic and/or features of Admin Q logic 156 may be capable of checking each read/write request or command at an SQ of a given ANQP to make sure each submitted read/write request or command only accesses the namespaces attached to that given ANQP or has appropriate access rights to the namespaces.

According to some examples, host computing platform 100 may include, but is not limited to, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof.

In some examples, processor 110 may include various commercially available processors, including without limitation an AMD® Athlon®, Duron® and Opteron® processors; NVIDIA® Tegra® processors; ARM® application, embedded and secure processors; IBM® and Motorola® DragonBall® and PowerPC® processors; IBM and Sony® Cell processors; Intel® Atom®, Celeron®, Core (2) Duo®, Core i3, Core i5, Core i7, Itanium®, Pentium®, Xeon® or Xeon Phi® processors; and similar processors.

According to some examples, host physical memory or storage 120 may be composed of one or more memory devices or dies which may include various types of volatile and/or non-volatile memory (e.g., arranged as an SSD and/or a dual in-line memory module (DIMM)). Also, ANQPs 151-1 to 151-N may each have one or more SQs and CQ which may be maintained in one or more memory devices or dies at or accessible to NVMe device 150. The one or more memory devices or dies included in host physical memory or storage 120 or maintained at or accessible to NVMe device 150 may include various types of volatile and/or non-volatile memory. Volatile memory may include, but is not limited to, random-access memory (RAM), Dynamic RAM (D-RAM), double data rate synchronous dynamic RAM (DDR SDRAM), static random-access memory (SRAM), thyristor RAM (T-RAM) or zero-capacitor RAM (Z-RAM). Non-volatile memory may include, but is not limited to, non-volatile types of memory such as 3-dimensional (3-D) cross-point memory that may be byte or block addressable. These block addressable or byte addressable non-volatile types of memory may include, but are not limited to, memory that uses chalcogenide phase change material (e.g., chalcogenide glass), multi-threshold level NAND flash memory, NOR flash memory, single or multi-level phase change memory (PCM), resistive memory, nanowire memory, ferroelectric transistor random access memory (FeTRAM), magnetoresistive random access memory (MRAM) memory that incorporates memristor technology, or spin transfer torque MRAM (STT-MRAM), or a combination of any of the above, or other non-volatile memory types.

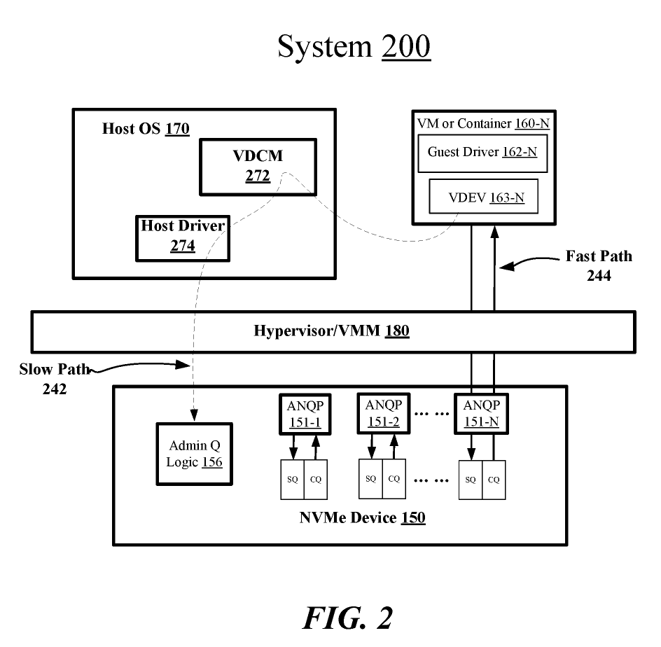

FIG. 2 illustrates an example system 200. In some examples, as shown in FIG. 2, system 200 may include elements of host computing platform 100 shown in FIG. 1 such as NVMe device 150, VM or container 160-N, host OS 170 and hypervisor/VMM 180. According to some examples, host OS 170 may provide a virtual device composition module (VDCM) 272. VDCM 272 may be capable of emulating control access to I/O access controllers or devices such as NVMe device 150 for virtualized elements such as VDEV 163-N of guest driver 162-N of VM or container 160-N. For example, VDCM 272 may emulate controller register sets for NVMe device 150 to be accessed by VDEV 163-N. Privileged commands may be trapped by VDCM 272 and then executed by a host driver also provided by host OS 170 such as host driver 274.

According to some examples, host driver 274 may control or manage at least portions of NVMe device 150 via the privileged commands trapped by VDCM 272. For these examples, the privileged commands may be routed via a slow path 242 to logic and/or features at NVMe device 150 such as Admin Q logic 156. Also, host driver 274 may support requirements/interfaces with hypervisor/VMM 180 to enable hypervisor/VMM 180 to enumerate, configure or provision ANQPs at NVMe device 150 in collaboration with Admin Q logic 156 and VDEV 163-N controlled by guest driver 162-N at container 160-N via slow path 242. For example, ANQP 151-N may be given a unique PASID and assigned to VM or container 160-N via Admin commands routed via slow path 242. Once ANQP 151-N has been assigned to VM or container 160-N, fast path 244 may be utilized such that VDEV 163-N controlled by guest driver 162-N may send read/write requests to NVMe device 150 and assigned ANQP 151-N without involvement of Host OS 170, host driver 274 or hypervisor/VMM 180.

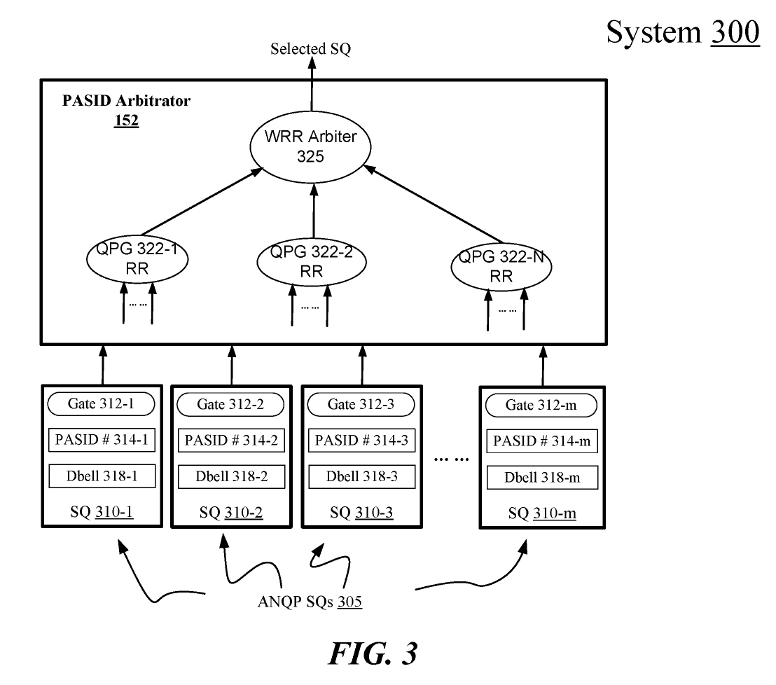

FIG. 3 illustrates an example system 300. In some examples, as shown in FIG. 3, system 300 may include elements of host computing platform 100 such as PASID arbitrator 152. As briefly mentioned above, PASID arbitrator 152 may be arranged to support arbitration between individual or groups of ANQPs having requests in their respective SQs. According to some examples, ANQP SQs 305 may be part of individual or groups of ANQPs included in ANQPs 151-1 to 151-N of NVMe device 150. As shown in FIG. 3, ANQP SQs 350 may include SQs 310-1 to 310-m, where “m” may be any positive whole integer greater than 3.

According to some examples, SQs 310-1 to 310-m may individually include a gate 312, a PASID #314 and a doorbell (Dbell) 318. For these examples, gate 312 may include an indicator bit or flag to let PASID arbitrator 152 know that read/write request or command is ready for selection. PASID #314 may include a uniquely assigned PASID that may be derived from a 20-bit PASID prefix header included in a PCIe read or write TLP received from a container that sent the read/write request or command. Dbell 312 may be a mechanism via which a guest driver at a VM or container may notify elements of NVMe 150 such as Admin Q logic 156 that a read/write request or command has been submitted and placed in one of SQs 310-1 to 310-m. Once notified, for example, Admin Q logic 156 may activate gate 312-1 (e.g. assert an indicator bit) to indicate to PASID arbitrator 152 that a read/write request or command is ready for selection.

In some examples, SQs from among SQ 310-1 to 310-m may be grouped into queue pair groups (QPGs) 322-1 to 322-N. For these examples, PASID arbitrator 152 may include logic and/or features to first implement a round robin (RR) arbitration scheme among SQs included in a given QPG and then utilize a weighted round robin (WRR) arbitrator 325 to select an SQ from among the RR selected QPGs 322-1 to 322-N. WWR arbitrator 325 may be arranged to base selection on credits available according to an WRR arbitration scheme or algorithm. The WRR arbitration scheme or algorithm may take into consideration QoS/bandwidth requirements associated with VMs or containers or groups of VMs/containers having commands included in SQs 310-1 to 310-m. The QoS/bandwidth requirements may weigh selection by WRR arbiter 325 by providing more credits to SQs assigned to VMs or containers having stricter or higher QoS/bandwidth requirements that may need relatively low latency times to fulfill read/write requests compared to SQs assigned to VM or containers having less strict or lower QoS/bandwidth requirements (e.g., measured in IO per second (TOPS)).

According to some examples, at least two or more SQs from among ANQP SQs 305 may be grouped into one of QPGs 322-1 to 322-N. For these examples, groupings may be based on the at least two or more SQs being part of ANQPs assigned to a same VM or container or assigned to similar types of VMs or containers. Similar types of VMs or containers may be based on such criteria as similar QoS/bandwidth requirements. Similar types of VMs or containers may also be based on types of applications executed or supported by these similar types of VMs or containers. Similar types of VMs or containers may also be based on types of tenants associated with VMs and/or containers. For example, types of tenants may include, but are not limited to, telecommunication tenants, financial service tenants, media content streaming tenants, social media tenants or ecommerce tenants.

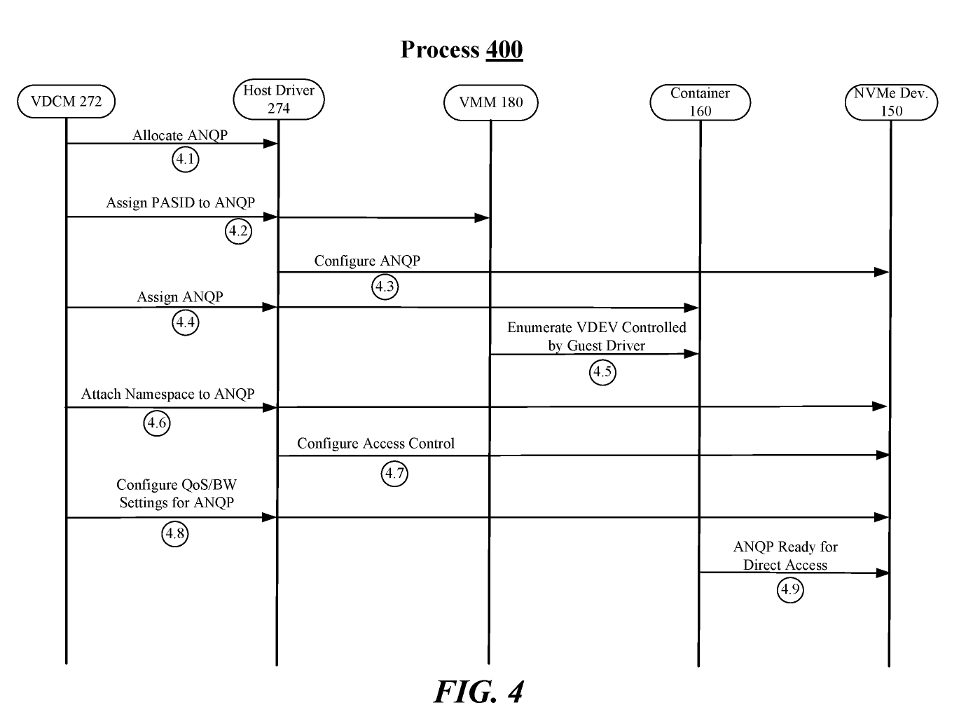

FIG. 4 illustrates an example process 400. In some examples, process 400 may be for initialization of an ANQP assignment to a VM or container for use of a PASID to facilitate I/O access to a host physical memory or storage by the container. For these examples, elements of host computing platform 100 as shown in FIG. 1 may be related to process 400. These elements of host computing platform 100 may include host OS 170, host driver 274, VMM/hypervisor 180 (VMM 180), NVMe device 150 or VDEV 163-1 controlled by guest driver 162 of VM or container 160. Also, as shown in FIG. 2 elements of system 200 such as VDCM 272 may be related to process 400. Also, as shown in FIG. 3 elements of system 300 such as ANQPs 305 or SQs 310-1 to 310-m may be related to process 400. However, example process 400 is not limited to implementations using elements of host computing platform 100, system 200 or system 300 shown in FIGS. 1-3.

Beginning at process 4.1 (Allocate ANQP), VDCM 272 may allocate an ANQP at NVMe device 150 based on capability information discovered or known of about NVMe device 150. In some examples, the allocated ANQP may include an SQ and CQ pair maintained at NVMe device 150.

Moving to process 4.2 (Assign PASID to ANQP), VDCM 272 may assign a unique PASID for the allocated ANQP and provide the unique PASID to host driver 274 and VMM 180.

Moving to process 4.3 (Configure ANQP), host driver 274 may cause NVMe device 150 to configure the ANQP for receiving read/write and commands having the unique PASID in an SQ included in the ANQP and sending completion indications via a CQ also included in the ANQP that also has the unique PASID.

Moving to process 4.4 (Assign ANQP), VDCM 274 may assign the ANQP to VM or container 160 and provide assignment information for this assignment to host driver 274. According to some examples, assignment of the ANQP to VM or container 160 may include providing the PASID to NVMe device 150.

Moving to process 4.5 (Enumerate VDEV Controlled by Guest Driver), VMM/hypervisor 180 may enumerate VDEV 163-1 controlled by guest driver 162 of VM or container 160. According to some examples, VDEV 163-1 may be arranged to facilitate direct access to the assigned ANQP by VM or container 160 to submit read/write requests or commands and to receive completion indications for submitted read/write requests or commands.

Moving to process 4.6 (Attach Namespace to ANQP), VDCM 272 may attach a namespace to the ANQP. The namespace may be used to represent a disk drive to elements of host computing platform 100 such as OS 170 and/or container 160. The namespace may be attached via Admin commands routed via slow path 242 to both host driver 274 and to Admin Q logic 156 at NVMe device 150. In some examples, although not shown in FIG. 4, VDCM 272 may also provide the namespace to VM or container 160. The attached namespace, for example, may include a range of GPAs that may be mapped to an allocated portion of host physical memory or storage 120.

Moving to process 4.7 (Configure Access Control), host driver 274 may configure access control for the attached namespace. According to some examples, the access control may be configured via Admin commands routed via slow path 242 to Admin Q logic 156 of NVMe device 150. Responsive to the access control configuration of the ANQP, Admin Q logic 156 may be capable of checking each read/write request or command at an SQ or CQ of the ANQP to make sure each read/write request or command only accesses the namespace attached to the ANQP or the read/write request has appropriate access rights (e.g. write access for a write request).

Moving to process 4.8 (Configure QoS/BW Settings for ANQP), VDCM 272 may configure QoS/bandwidth settings for the ANQP at NVMe device 150. In some examples, VDCM 272 may relay QoS/bandwidth requirements to host driver 274. VDCM 272 may also relay QoS/bandwidth requirements to PASID arbiter 152 at NVMe device 150 to configure QoS/bandwidth settings for the ANQP to use in RR or WRR arbitration schemes as described previously for FIG. 3. For these examples, the configured QoS/Bandwidth settings for the ANQP may be specific for the ANQP, may apply to the assigned PASID or may apply to a container that may be assigned to use the ANQP.

Moving to process 4.9 (ANQP Ready for Direct Access), VM or container 160 via VDEV 163 controlled by guest driver 162 may now have an assigned ANQP ready for direct access. Process 400 may then come to an end.

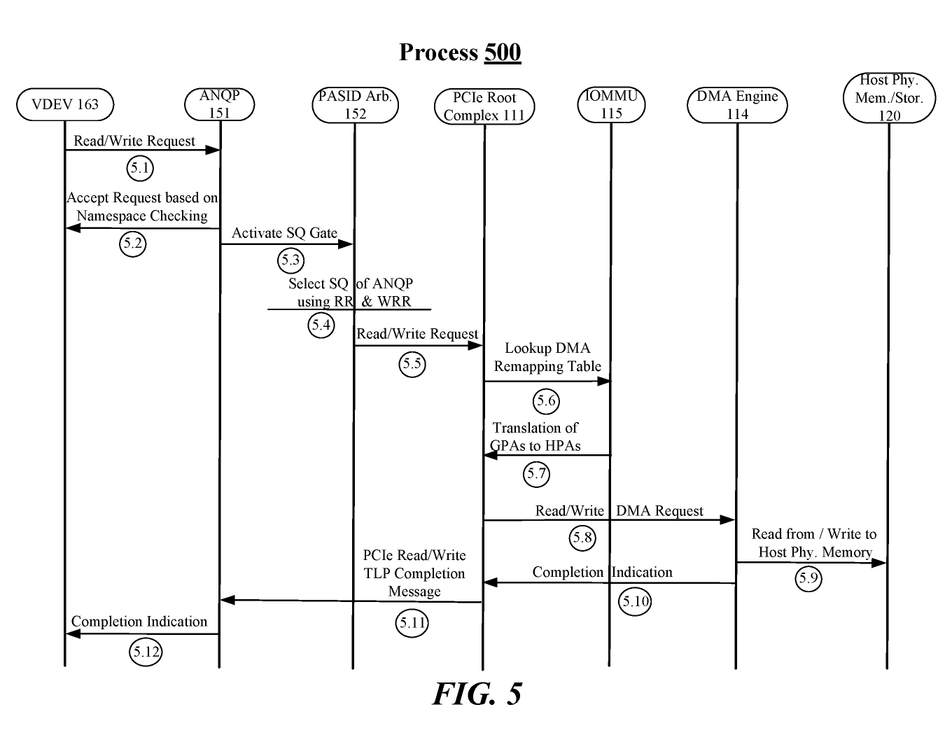

FIG. 5 illustrates an example process 500. In some examples, process 500 may be for showing examples of runtime processes for a read/write request or command submitted by a VDEV controlled by a guest driver of a container or VM to an I/O access device arranged to control access to host physical memory or storage for a host computing platform hosting the container or VM. For these examples, process 500 may follow initialization of an ANQP as described for process 400 and shown in FIG. 4. Elements of host computing platform 100 as shown in FIG. 1 may be related to process 500. These elements of host computing platform 100 may include VDEV 163 controlled by guest driver 162 of VM or container 160, ANQP 151, Admin Q logic 156 and PASID arbiter 152 at NVMe device 150, PCIe root complex 111, IOMMU 115 and DMA engine 114 at processor 110 or host physical memory or storage 120. Also, elements of system 300 such as ANQP SQs 305, QPG 322 or WRR arbiter 325 as shown in FIG. 3 may also be related to process 500. However, example process 500 is not limited to implementations using elements of host computing platform 100 or system 300 shown in respective FIG. 1 and FIG. 3.

Beginning at process 5.1 (Read/Write Request), a read/write request may be submitted directly to an SQ of ANQP 151 at NVMe device 150 by VDEV 163 controlled by guest driver 162 of container 160. In some examples, the read/write request may include GPAs for read/write access by VM or container 160 to host physical memory or storage 120.

Moving to process 5.2 (Accept Request based on Namespace Checking), logic and/or features at NVMe device 150 such as Admin Q logic 156 may accept the read/write request based on namespace checking. The namespace attached to the ANQP may include a range of GPAs mapped to host physical memory or storage. In some examples, if the GPAs included in the received read/write request fall within the range of GPAs, Admin Q logic 156 may accept the read/write request.

Moving to process 5.3 (Activate Submission Queue Gate), logic and/or features of NVMe device 150 such as Admin Q logic 156 may activate an SQ gate for an SQ included in ANQP 151 to indicate to PASID arbiter 152 that a received and accepted read/write request has been placed in the SQ. In some examples, the SQ included in ANQP 151 may be configured similar to ANQP SQs 305 shown in FIG. 3 and described above.

Moving to process 5.4 (Select SQ of ANQP using RR and WRR), logic and/or features of NVMe device 150 such as PASID arbiter 152 may first complete an RR arbitration scheme for a QPG for which the SQ included in ANQP 151 may have been grouped and WRR arbiter 325 of PASID arbiter 152 may complete a WRR arbitration scheme to select the SQ of ANQP 151. In some examples, PASID arbiter and WRR arbiter 323 may complete the RR and WRR arbitration schemes as described above for FIG. 3.

Moving to process 5.5 (Read/Write Request), logic and/or features of NVMe device 150 such as PASID arbiter 152 may cause the read/write request included in the selected SQ of ANQP 151 to be forwarded to PCIe root complex 111 at processor 110. According to some examples, the read/write request may be included in a PCIe read or write TLP. For these examples, the PCIe read or write TLP may include at least one GPA for read/write access by VM or container 160 to host physical memory or storage 120 and also includes a PASID that has been assigned to ANQP 151.

Moving to process 5.6 (Lookup DMA Remapping Table), logic and/or features of PCIe root complex 111, responsive to receiving the PCIe read or write TLP, may send the PASID and the at least one GPA included in the received PCIe read or write TLP to IOMMU 115 via 110 bus 116 to utilize lookup DMA remapping table 109.

Moving to process 5.7 (Translation of GPAs to HPAs), logic and/or features of IOMMU 115 may utilize the PASID and lookup DMA remapping table 109 to translate the at least one GPA included in the received PCIe read or write TLP. In some examples, the translation from the at least one GPA to at least one HPA is needed because DMA engine 114 may operate using HPAs to perform read or write operations to host physical memory or storage 120.

Moving to process 5.8 (Read/Write DMA Request), logic and/or features of PCIe root complex 111 may generate a read/write DMA request to DMA engine 114 that includes replacing the at least one GPA indicated in the received PCIe read or write TLP with the translated at least one HPA provided by IOMMU 115. The read/write DMA request may be made via IIO bus 116 to DMA engine 114.

Moving to process 5.9 (Read from/Write to Host Phy. Memory), responsive to the read/write DMA request, logic and/or features of DMA engine 114 may activate a DMA channel via ring bus 117 for a DMA transaction to host physical memory or storage 120 to cause a read from or a write to host physical memory or storage 120. According to some examples, the read from or write to host physical memory or storage 120 may be based on the at least one HPA translated by IOMMU 115.

Moving to process 5.10 (Completion Indication), logic and/or features of DMA engine 114 may send a DMA transaction done message to PCIe root complex 111 to indicate that read/write access to host physical memory or storage 120 has been completed. The indication, for example, includes the PASID assigned to ANQP 151.

Moving to process 5.11 (PCIe Read/Write TLP Completion Message), responsive to receiving the DMA transaction done message, logic and/or features of PCIe root complex 111 may generate a PCIe read or write TLP completion message that includes the PASID assigned to ANQP 151. The PCIe read or write TLP completion message may also include the at least one GPA included in the PCIe read or write TLP that was sent to PCIe root complex in process 5.5.

Moving to process 5.12 (Completion Indication), a completion indication may be received in a CQ of ANQP 151. According to some examples, logic and/or features at NVMe device 150 may cause an indication to be sent or provided to VDEV 163 controlled by guest driver 162 (e.g., a doorbell) to indicate that a completion indication is included in the CQ of ANQP 151. In some examples, the completion indication may include the at least one GPA received with the PCIe read or write TLP completion message from PCIe root complex 111. Process 500 may then come to an end.

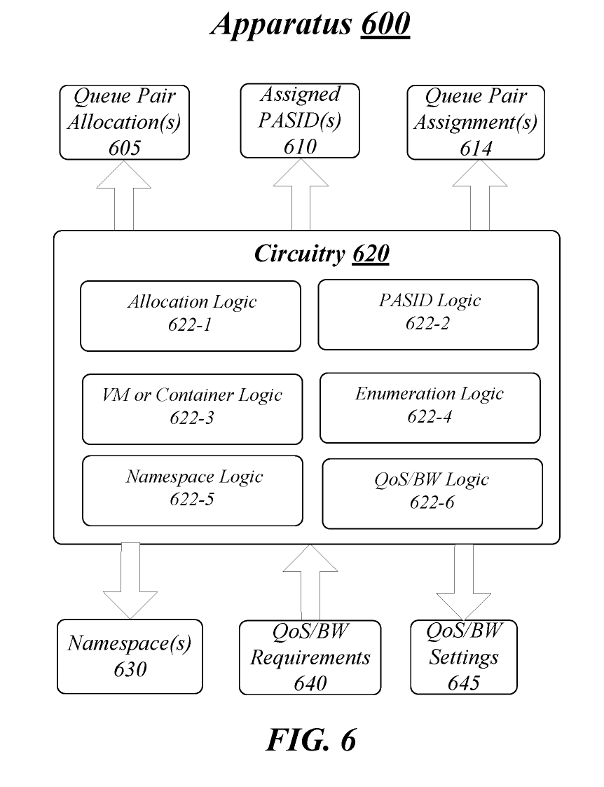

FIG. 6 illustrates an example block diagram for apparatus 600. Although apparatus 600 shown in FIG. 6 has a limited number of elements in a certain topology, it may be appreciated that the apparatus 600 may include more or less elements in alternate topologies as desired for a given implementation.

According to some examples, apparatus 600 may be part of a host computing platform for supporting one or more VMs or containers. Circuitry 620 may be arranged to execute one or more software or firmware implemented modules, components or logic 622-a (module, component or logic may be used interchangeably in this context) included in or implemented by the hypervisor or VMM. It is worthy to note that “a” and “b” and “c” and similar designators as used herein are intended to be variables representing any positive integer. Thus, for example, if an implementation sets a value for a=6, then a complete set of software or firmware for logic 622-a may include logic 622-1, 622-2, 622-3, 622-4, 622-5 or 622-6. The examples presented are not limited in this context and the different variables used throughout may represent the same or different integer values. Also, “logic” may also include software/firmware stored in computer-readable media, and although logic is shown in FIG. 6 as discrete boxes, this does not limit this logic to storage in distinct computer-readable media components (e.g., a separate memory, etc.).

According to some examples, circuitry 620 may include a processor, processor circuit or processor circuitry. Circuitry 620 may be generally arranged to execute logic 622-a. Circuitry 620 may be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Atom®, Celeron®, Core (2) Duo®, Core i3, Core i5, Core i7, Itanium®, Pentium®, Xeon®, Xeon Phi® and XScale® processors; and similar processors. According to some examples circuitry 620 may also include an application specific integrated circuit (ASIC) and at least some logic 622-a may be implemented as hardware elements of the ASIC. According to some examples, circuitry 620 may also include a field programmable gate array (FPGA) and at least some logic 622-a may be implemented as hardware elements of the FPGA.

According to some examples, apparatus 600 may include an allocation logic 622-1. Allocation indication logic 622-1 may be executed by circuitry 620 to allocate a queue pair including a submission queue and a completion queue maintained at a controller for I/O access to a host physical memory or storage for the host computing platform that maintains circuitry 620. For these examples, queue pair allocation(s) 605 may indicate what queue pair at the controller is to be allocated.

In some examples, apparatus 600 may include a PASID logic 622-2. PASID logic 622-2 may be executed by circuitry 620 to assign a PASID to the queue pair allocated by allocation logic 622-1 such that received read or write requests including the PASID are at least temporarily stored in the submission queue, the received read or write request for I/O access to the host physical memory or storage. For these examples, assigned PASID(s) 610 may include the PASID that is assigned to the queue pair.

According to some examples, apparatus 600 may also include a VM or container logic 622-3. VM or container logic 622-3 may be executed by circuitry 620 to assign the queue pair to a VM or container hosted by the host computing platform. For these examples, queue pair assignment(s) 615 may indicate what VM or container has been assigned to the queue pair.

In some examples, apparatus 600 may also include an enumerate logic 622-4. Enumerate logic 622-4 may enumerate a VDEV controlled by a guest driver of the VM or container, VDEV may be provide with information for use in sending read or write requests to the submission queue of the queue pair assigned to the VM or container for I/O access to the host physical memory or storage.

According to some examples, apparatus 600 may also include a namespace logic 622-5. Namespace logic 622-5 may be executed by circuitry 620 to attach a namespace to the queue pair to represent a disk drive to an operating system of the host computing platform and to provide access control to the at least portions of the host physical memory or storage. For these examples, namespace(s) 630 may indicate the namespace attached to the queue pair. In some examples, namespace logic 622-5 may send namespace(s) 630 to the VDEV controlled by the guest driver of the VM or container for the VDEV to include the attached namespace when sending read or write requests to the submission queue of the queue pair assigned to the VM or container.

According to some examples, apparatus 600 may also include a QoS/BW logic 622-6. QoS/BW logic 622-6 may be executed by circuitry 620 to configure QoS or bandwidth (BW) settings for the queue pair for use in one or more arbitration schemes implemented at the controller to select read or write requests sent to the submission queue by the VDEV controlled by the guest driver in comparison to other read or write requests in other submission queues maintained at the controller. For these examples, QoS/BW requirements 640 may be used to generate QoS/BW settings 645 for the queue pair for use in the one or more arbitration schemes.

Various components of apparatus 600 and a device or node implementing apparatus 600 may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Example connections include parallel interfaces, serial interfaces, and bus interfaces.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

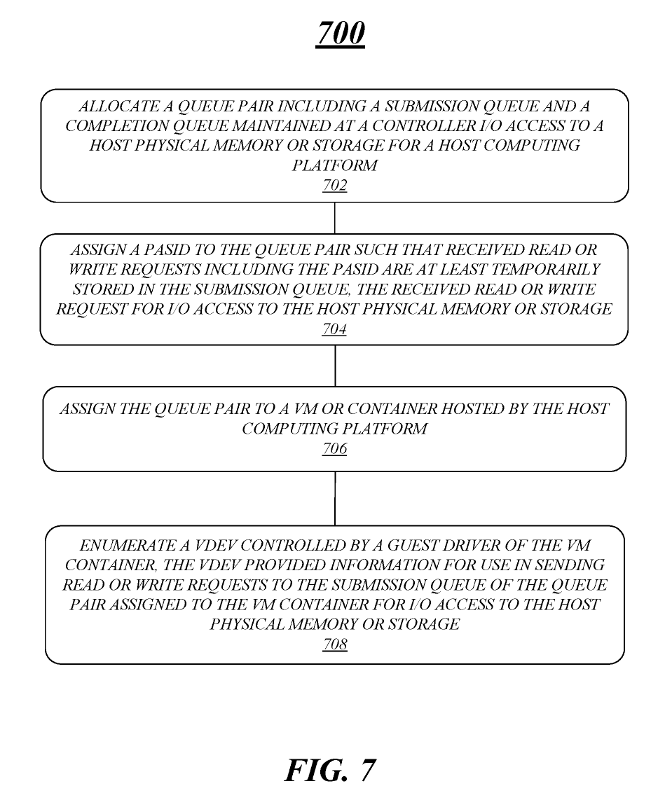

FIG. 7 illustrates an example logic flow 700. Logic flow 700 may be representative of some or all of the operations executed by one or more logic, features, or devices described herein, such as apparatus 600. More particularly, logic flow 700 may be implemented by allocation logic 622-1, PASID logic 622-2, VM or container logic 622-3 or enumerate logic 622-4.

According to some examples, logic flow 700 at block 702 may allocate a queue pair including a submission queue and a completion queue maintained at a controller I/O access to a host physical memory or storage for a host computing platform. For these examples, allocation logic 722-1 may allocate the queue pair.

In some examples, logic flow 700 at block 704 may assign a PASID to the queue pair such that received read or write requests including the PASID are at least temporarily stored in the submission queue, the received read or write request for I/O access to the host physical memory or storage. For these examples, PASID logic 622-2 may assign the PASID to the queue pair.

According to some examples, logic flow 700 at block 706 may assign the queue pair to a VM or container hosted by the host computing platform. For these examples, VM or container logic 622-3 may assigned the queue pair to the VM or container.

In some examples, logic flow 700 at block 708 may enumerate a VDEV controlled by a guest driver of the VM or container, the VDEV provided information for use in sending read or write requests to the submission queue of the queue pair assigned to the VM or container for I/O access to the host physical memory or storage. For these examples, enumerate logic 622-4 may enumerate the VDEV controlled by the guest driver of the VM or container in order to provide the information to the VDEV. The information may include namespace information attached to the queue pair.

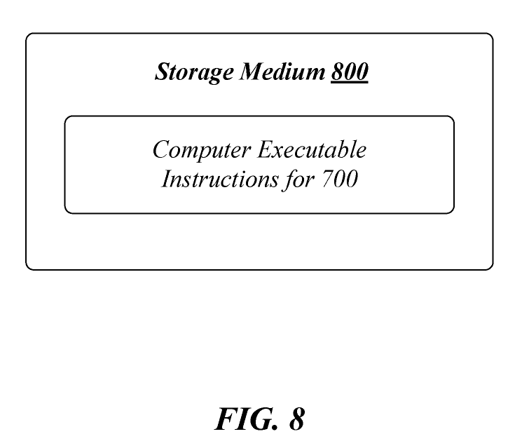

FIG. 8 illustrates an example storage medium 800. As shown in FIG. 8, the first storage medium includes a storage medium 800. The storage medium 800 may comprise an article of manufacture. In some examples, storage medium 800 may include any non-transitory computer readable medium or machine readable medium, such as an optical, magnetic or semiconductor storage. Storage medium 800 may store various types of computer executable instructions, such as instructions to implement logic flow 700. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

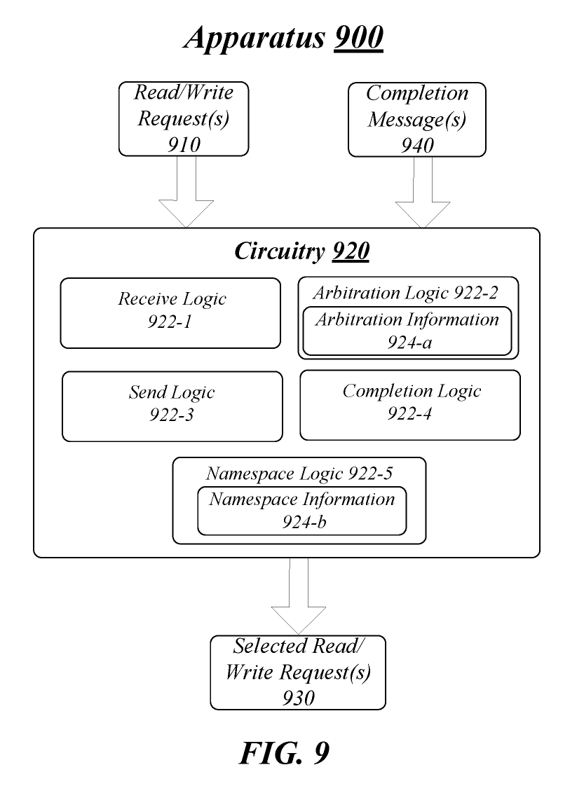

FIG. 9 illustrates an example block diagram for apparatus 900. Although apparatus 900 shown in FIG. 9 has a limited number of elements in a certain topology, it may be appreciated that the apparatus 900 may include more or less elements in alternate topologies as desired for a given implementation.

According to some examples, apparatus 900 may be supported by circuitry 920 maintained at a controller for I/O access to physical memory or storage for a host computing platform such as NVMe device 150 shown in FIG. 1. Circuitry 920 may be arranged to execute one or more software or firmware implemented modules, components or logic 922-a (module, component or logic may be used interchangeably in this context). It is worthy to note that “a” and “b” and “c” and similar designators as used herein are intended to be variables representing any positive integer. Thus, for example, if an implementation sets a value for a=5, then a complete set of software or firmware for logic 922-a may include logic 922-1, 922-2, 922-3, 922-4 or 922-5. The examples are not limited in this context and the different variables used throughout may represent the same or different integer values. Also, “logic” may also include software/firmware stored in computer-readable media, and although logic is shown in FIG. 9 as discrete boxes, this does not limit this logic to storage in distinct computer-readable media components (e.g., a separate memory, etc.).

According to some examples, circuitry 920 may include a processor, processor circuit or processor circuitry. Circuitry 920 may be generally arranged to execute logic 922-a. Circuitry 920 can be any of various commercially available processors to include but not limited to the processors mentioned above for apparatus 900. Also, according to some examples, circuitry 920 may also be an ASIC and at least some logic 922-a may be implemented as hardware elements of the ASIC.

According to some examples, apparatus 900 may include a receive logic 922-1. Receive logic 922-1 may be executed by circuitry 920 to receive a read or write request for I/O access to the physical memory or storage that includes a PASID and a GPA. The read or write request having the PASID and the GPA received in a submission queue of a queue pair maintained at the controller. The queue pair assigned to the PASID and also assigned to a VM or container hosted by the host computing platform. For these examples, the read or write request may be included in read/write request(s) 910.

In some examples, apparatus 900 may include an arbitration logic 922-2. Arbitration logic 922-2 may be executed by circuitry 920 to complete an arbitration scheme to select the read or write request in the submission queue from among one or more other read or write requests for I/O access to the physical memory or storage in one or more other submission queues maintained at the controller. For these examples, arbitration logic 922-2 may maintain algorithms (e.g., in a lookup table (LUT)) with arbitration information 924-a. The algorithms may be used in RR or WRR arbitration schemes to select the read or write request in the submission queue.

According to some examples, apparatus 900 may also include a send logic 922-3. Send logic 922-3 may be executed by circuitry 920 to send the read or write request including the PASID and the GPA to a processor of the host computing platform, the processor to translate the GPA to an HPA and cause a direct memory access transaction to the physical memory or storage to complete the I/O access to the physical memory or storage. For these examples, selected read/write request(s) 930 may include the sent read or write request.

In some examples, apparatus 900 may also include a completion logic 922-4. In some examples, receive logic 922-1 may receive a completion message from the processor of the host computing platform indicating completion of the I/O access to the physical memory or storage. Responsive to receiving the completion message, completion logic 922-4 may be executed by circuitry 920 to cause a read or write completion message to be included in a completion queue included with the submission queue to form the queue pair, the read or write completion message including at least the GPA. For these examples, completion message(s) 940 may include at least some of the information included in the completion message received by receive logic 922-1.

According to some examples, apparatus 900 may also include a namespace logic 922-5. Namespace logic 922-5 may be executed by circuitry 920 to accept the read or write request received in the submission queue of the queue pair based on a namespace attached to the queue pair matching a namespace associated with the GPA included in the read or write request. For these examples, namespace logic 922-5 may match the namespace associated with the GPA based on namespace information 924-b (e.g., maintained in a LUT).

Various components of apparatus 900 and a device implementing apparatus 900 may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Example connections include parallel interfaces, serial interfaces, and bus interfaces.

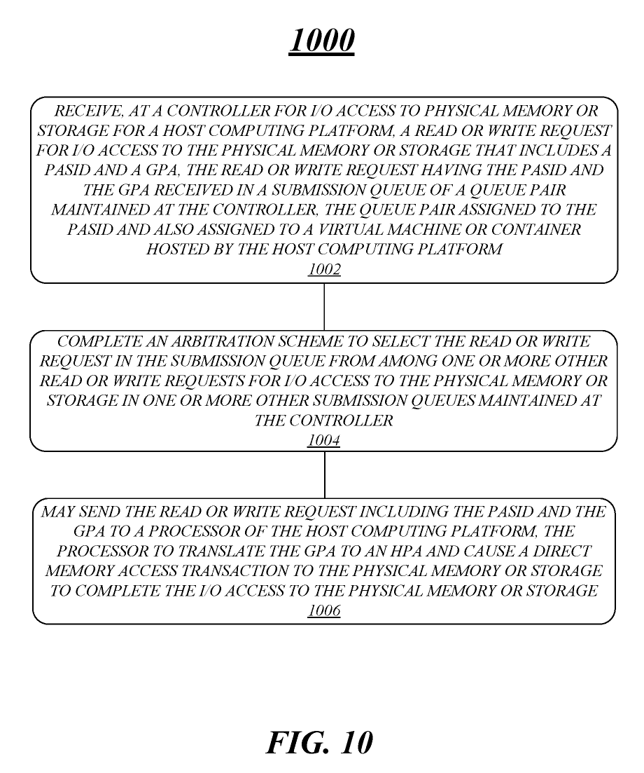

FIG. 10 illustrates an example logic flow 1000. Logic flow 1000 may be representative of some or all of the operations executed by one or more logic, features, or devices described herein, such as apparatus 900. More particularly, logic flow 1000 may be implemented by a receive logic 922-1, arbitration logic 1022-2 or send logic 1022-3.

According to some examples, logic flow 1000 at block 1002 may receive, at a controller for I/O access to physical memory or storage for a host computing platform, a read or write request for I/O access to the physical memory or storage that includes a PASID and a GPA, the read or write request having the PASID and the GPA received in a submission queue of a queue pair maintained at the controller, the queue pair assigned to the PASID and also assigned to a VM or container hosted by the host computing platform. For these examples, receive logic 922-1 may receive the read or write request.

In some examples, logic flow 1000 at block 1004 may complete an arbitration scheme to select the read or write request in the submission queue from among one or more other read or write requests for I/O access to the physical memory or storage in one or more other submission queues maintained at the controller. For these examples, arbitration logic 922-2 may complete the arbitration scheme.

According to some examples, logic flow 1000 at block 1006 may send the read or write request including the PASID and the GPA to a processor of the host computing platform, the processor to translate the GPA to an HPA and cause a direct memory access transaction to the physical memory or storage to complete the I/O access to the physical memory or storage. For these examples, send logic 922-3 may send the read or write request.

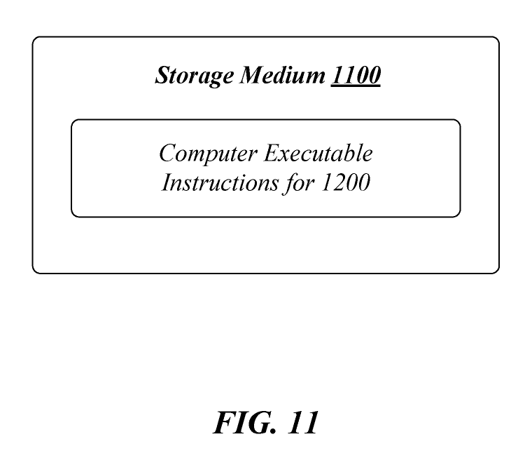

FIG. 11 illustrates an example storage medium 1100. As shown in FIG. 11, the first storage medium includes a storage medium 1100. The storage medium 1100 may comprise an article of manufacture. In some examples, storage medium 1100 may include any non-transitory computer readable medium or machine readable medium, such as an optical, magnetic or semiconductor storage. Storage medium 1100 may store various types of computer executable instructions, such as instructions to implement logic flow 1000. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

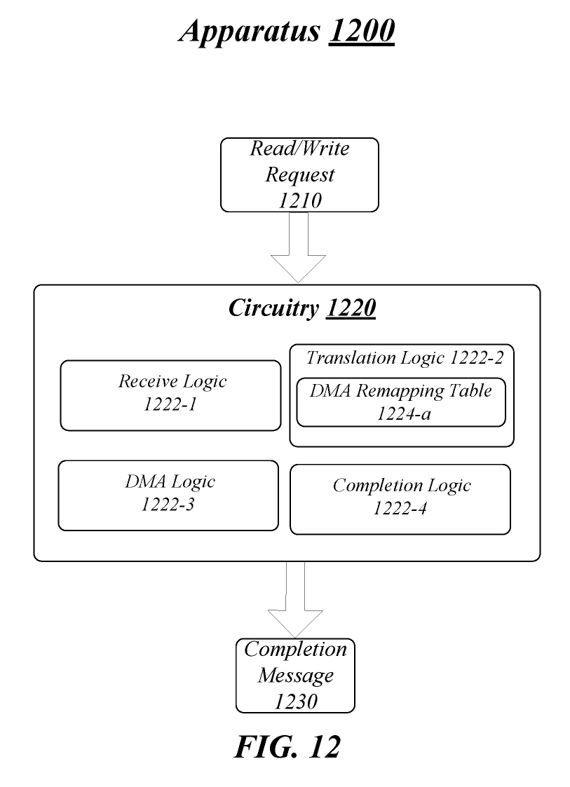

FIG. 12 illustrates an example block diagram for apparatus 1200. Although apparatus 1200 shown in FIG. 12 has a limited number of elements in a certain topology, it may be appreciated that the apparatus 1200 may include more or less elements in alternate topologies as desired for a given implementation.

According to some examples, apparatus 1200 may be supported by circuitry 1220 at a processor for a host computing platform supporting one or more VMs or containers. Circuitry 1220 may be arranged to execute one or more software or firmware implemented modules, components or logic 1222-a (module, component or logic may be used interchangeably in this context). It is worthy to note that “a” and “b” and “c” and similar designators as used herein are intended to be variables representing any positive integer. Thus, for example, if an implementation sets a value for a=4, then a complete set of software or firmware for logic 1222-a may include logic 1222-1, 1222-2, 1222-3 or 1222-4. The examples are not limited in this context and the different variables used throughout may represent the same or different integer values. Also, “logic” may also include software/firmware stored in computer-readable media, and although logic is shown in FIG. 12 as discrete boxes, this does not limit this logic to storage in distinct computer-readable media components (e.g., a separate memory, etc.).

According to some examples, circuitry 1220 may include a processor, processor circuit or processor circuitry. Circuitry 1220 may be generally arranged to execute logic 1222-a. Circuitry 1220 can be any of various commercially available processors to include but not limited to the processors mentioned above for apparatus 1200. Also, according to some examples, circuitry 1220 may also be an ASIC and at least some logic 1222-a may be implemented as hardware elements of the ASIC.

According to some examples, apparatus 1200 may include a receive logic 1222-1. Receive logic 1222-1 may be executed by circuitry 1220 to receive a read or write request for I/O access to physical memory or storage for the host computing platform. The read or write request received from a controller coupled with the processor and including a PASID and a GPA. For these examples, the read or write request may be included in read/write request 1210.

In some examples, apparatus 1200 may include a translation logic 1222-2. Translation logic 1222-2 may be executed by circuitry 1220 to translate the GPA to an HPA via use of an IOMMU. For these examples, transaction logic 1222-2 may have access to DMA remapping table 1224-a maintained at the IOMMU. DMA remapping table 1224-a may enable translation logic 1222-2 to complete the translation of the GPA to the HPA.

According to some examples, apparatus 1200 may also include DMA logic 1222-3. DMA logic 1222-3 may be executed by circuitry 1220 to cause a DMA transaction to the physical memory or storage using the HPA to complete the I/O access to the physical memory or storage. For these examples, DMA logic 1222-3 may use a DMA engine at the processor to read or write data to the physical memory or storage based on the HPA.

In some examples, apparatus 1200 may also include a completion logic 1222-4. Completion logic 1222-4 may be executed by circuitry 1220 to send to send a completion message to the controller indicating completion of the I/O access to the physical memory or storage. For these examples, the completion message may be included in completion message 1240.

Various components of apparatus 1200 and a device implementing apparatus 1200 may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Example connections include parallel interfaces, serial interfaces, and bus interfaces.

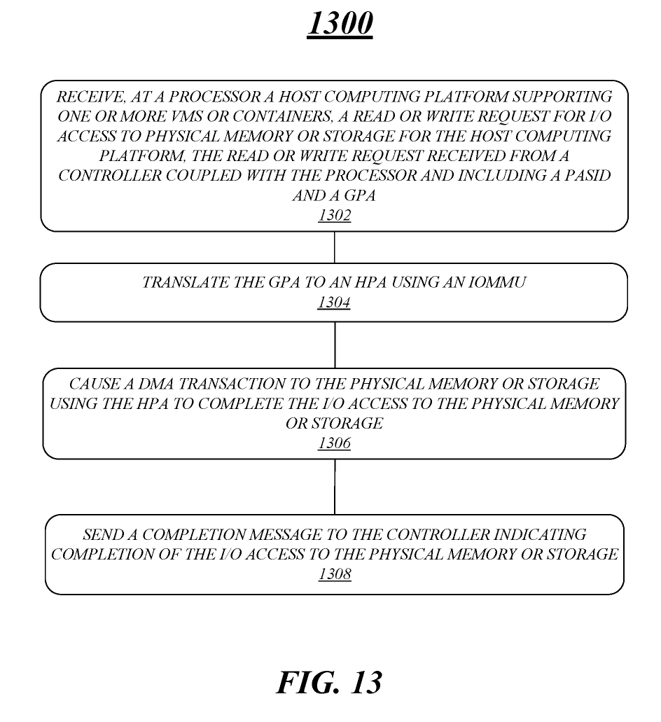

FIG. 13 illustrates an example logic flow 1300. Logic flow 1300 may be representative of some or all of the operations executed by one or more logic, features, or devices described herein, such as apparatus 1200. More particularly, logic flow 1300 may be implemented by receive logic 1222-1, translation logic 1222-2, DMA logic 1222-3 or completion logic 1222-4.

According to some examples, logic flow 1300 at block 1302 may receive, at a processor a host computing platform supporting one or more VM or containers, a read or write request for I/O access to physical memory or storage for the host computing platform, the read or write request received from a controller coupled with the processor and including a PASID and a GPA. For these examples, receive logic 1222-1 may receive the read or write request message. In some examples, logic flow 1300 at block 1304 may translate the GPA to an HPA using an IOMMU. For these examples, translation logic 1222-2 may translate the GPA to the HPA using the IOMMU.

According to some examples, logic flow 1300 at block 1306 may cause a DMA transaction to the physical memory or storage using the HPA to complete the I/O access to the physical memory or storage. For these examples, DMA logic 1222-3 may cause the DMA transaction.

In some examples, logic flow 1300 at block 1308 may send a completion message to the controller indicating completion of the I/O access to the physical memory or storage. For these examples, completion logic 1222-4 may send the completion message.

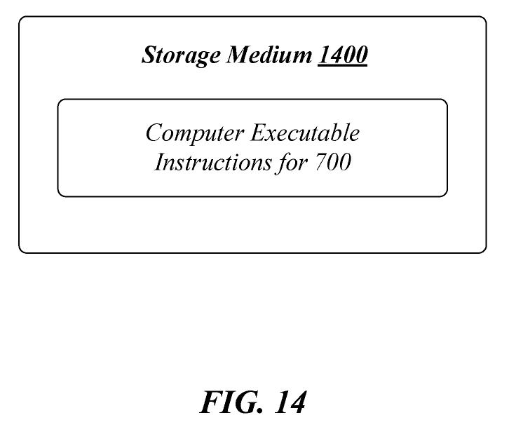

FIG. 14 illustrates an example storage medium 1400. As shown in FIG. 14, the first storage medium includes a storage medium 1400. The storage medium 1400 may comprise an article of manufacture. In some examples, storage medium 1400 may include any non-transitory computer readable medium or machine readable medium, such as an optical, magnetic or semiconductor storage. Storage medium 1400 may store various types of computer executable instructions, such as instructions to implement logic flow 1300. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

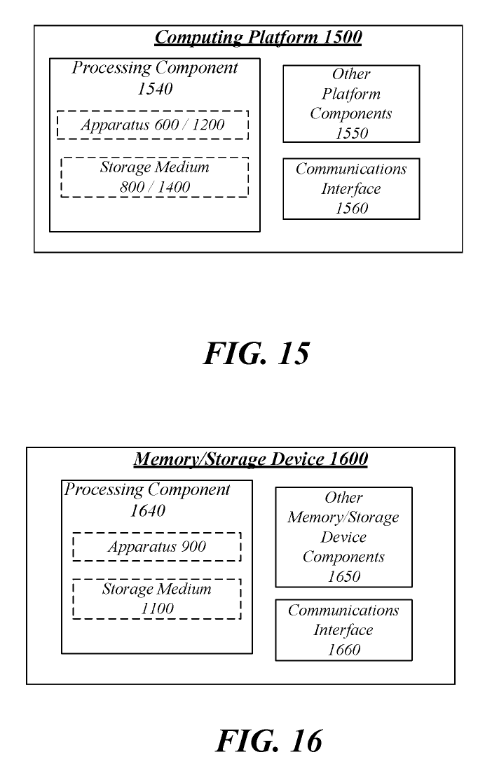

FIG. 15 illustrates an example computing platform 1500. In some examples, as shown in FIG. 15, computing platform 1500 may include a processing component 1540, other platform components 1550 or a communications interface 1560.

According to some examples, processing component 1540 may execute processing operations or logic for apparatus 600/1200 and/or storage medium 800/1400. Processing component 1540 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 1550 may include common computing elements, memory units, chipsets, controllers, peripherals, interfaces, oscillators, timing devices, video cards, audio cards, multimedia input/output (I/O) components (e.g., digital displays), power supplies, and so forth. Examples of memory units or memory devices may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 1560 may include logic and/or features to support a communication interface. For these examples, communications interface 1560 may include one or more communication interfaces that operate according to various communication protocols or standards to communicate over direct or network communication links. Direct communications may occur via use of communication protocols or standards described in one or more industry standards (including progenies and variants) such as those associated with the PCIe specification, the NVMe specification or the SAS-3 specification. Network communications may occur via use of communication protocols or standards such those described in one or more Ethernet standards promulgated by IEEE such as IEEE 802.3. Network communication may also occur according to one or more OpenFlow specifications such as the OpenFlow Hardware Abstraction API Specification. Network communications may also occur according to Infiniband Architecture specification.

As mentioned above computing platform 1500 may be implemented in a server or client computing device. Accordingly, functions and/or specific configurations of computing platform 1500 described herein, may be included or omitted in various embodiments of computing platform 1500, as suitably desired for a server or client computing device.

The components and features of computing platform 1500 may be implemented using any combination of discrete circuitry, application specific integrated circuits (ASICs), logic gates and/or single chip architectures. Further, the features of computing platform 1500 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary computing platform 1500 shown in the block diagram of FIG. 15 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

FIG. 16 illustrates an example memory/storage device 1600. In some examples, as shown in FIG. 16, storage device 1600 may include a processing component 1640, other storage device components 1650 or a communications interface 1660. According to some examples, memory/storage device 1600 may be capable of being coupled to a host computing device or platform.

According to some examples, processing component 1640 may execute processing operations or logic for apparatus 900 and/or storage medium 1100. Processing component 1640 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, ASIC, PLDs, DSPs, FPGA/programmable logic, memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software components, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other memory/storage device components 1650 may include common computing elements or circuitry, such as one or more processors, multi-core processors, co-processors, memory units, chipsets, controllers, interfaces, oscillators, timing devices, power supplies, and so forth. Examples of memory units may include without limitation various types of computer readable and/or machine readable storage media in the form of one or more higher speed memory units, such as ROM, RAM, DRAM, DDR DRAM, SDRAM, DDR SDRAM, SRAM, PROM, EPROM, EEPROM, flash memory, ferroelectric memory, SONOS memory, polymer memory such as ferroelectric polymer memory, nanowire, FeTRAM or FeRAM, ovonic memory, phase change memory, memristers, STT-MRAM, magnetic or optical cards, and any other type of storage media suitable for storing information.

In some examples, communications interface 1660 may include logic and/or features to support a communication interface. For these examples, communications interface 1660 may include one or more communication interfaces that operate according to various communication protocols or standards to communicate over direct or network communication links. Direct communications may occur via use of communication protocols such as SMBus, PCIe, NVMe, QPI, SATA, SAS or USB communication protocols. Network communications may occur via use of communication protocols such as Ethernet, Infiniband, SATA or SAS communication protocols.

Memory/storage device 1600 may be arranged as an SSD that may provide at least a portion of physical memory or storage for a host computing system. Accordingly, functions and/or specific configurations of memory/storage device 1600 described herein, may be included or omitted in various embodiments of memory/storage device 1600, as suitably desired.

The components and features of memory/storage device 1600 such as, but not limited to, processing component 1640 may be implemented using any combination of discrete circuitry, ASICs, logic gates and/or single chip architectures. Further, the features of memory/storage device 1600 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the example memory/storage device 1600 shown in the block diagram of FIG. 16 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled” or “coupled with”, however, may also mean that two or more elements are not in direct contact with each other, but yet still co-operate or interact with each other.

The follow examples pertain to additional examples of technologies disclosed herein.

### Example 1

An example apparatus may include circuitry at a host computing platform for supporting one or more virtual machines containers. The apparatus may also include allocation logic for execution by the circuitry to allocate a queue pair that includes a submission queue and a completion queue maintained at a controller for input/output (I/O) access to a host physical memory or storage for the host computing platform. The apparatus may also include PASID logic for execution by the circuitry to assign a PASID to the queue pair such that received read or write requests including the PASID are at least temporarily stored in the submission queue, the received read or write request for I/O access to the host physical memory or storage. The apparatus may also include container logic for execution by the circuitry to assign the queue pair to a VM or container hosted by the host computing platform. The apparatus may also include enumerate logic for execution by the circuitry to enumerate a VDEV controlled by a guest driver of the VM or container, the guest driver provided information for use in sending read or write requests to the submission queue of the queue pair assigned to the VM or container for I/O access to the host physical memory or storage.

### Example 2

The apparatus of example 1 may also include namespace logic for execution by the circuitry to attach a namespace to the queue pair to represent a disk drive to an operating system of the host computing platform and to provide access control to the at least portions of the host physical memory or storage. For these examples, the namespace logic may provide the namespace to the VDEV for the VDEV to include the namespace when sending read or write requests to the submission queue.

### Example 3

The apparatus of example 1 may also include QoS/BW logic for execution by the circuitry to configure QoS or BW settings for the queue pair for use in one or more arbitration schemes implemented at the controller to select read or write requests sent to the submission queue by the VDEV in comparison to other read or write requests in other submission queues maintained at the controller.

### Example 4

The apparatus of example 3, the one or more arbitration schemes may include a round robin arbitration scheme or a weighted round robin arbitration scheme.

### Example 5

The apparatus of example 1, the controller may operate according to a PCIe specification. For these examples, the PASID assigned to the queue pair may be a 20-bit prefix header to be included in read or write requests sent by the controller for I/O access to the host physical memory or storage.

### Example 6

The apparatus of example 5, the controller may also operate according to a NVMe specification or a SAS specification.

### Example 7

The apparatus of example 1, the host physical memory or storage may include volatile memory or non-volatile memory. For these examples, the volatile memory includes dynamic random access memory (DRAM) and the non-volatile memory includes 3-dimensional cross-point memory, memory that uses chalcogenide phase change material, multi-threshold level NAND flash memory, NOR flash memory, single or multi-level phase change memory (PCM), resistive memory, ovonic memory, nanowire memory, ferroelectric transistor random access memory (FeTRAM), magnetoresistive random access memory (MRAM) memory that incorporates memristor technology, or spin transfer torque MRAM (STT-MRAM).

### Example 8

An example method may include allocating a queue pair including a submission queue and a completion queue maintained at a controller for input/output (I/O) access to a host physical memory or storage for a host computing platform. The method may also include assigning a PASID to the queue pair such that received read or write requests including the PASID are at least temporarily stored in the submission queue, the received read or write request for I/O access to the host physical memory or storage. The method may also include assigning the queue pair to a VM or container hosted by the host computing platform. The method may also include enumerating a VDEV controlled by a guest driver of the VM or container, the VDEV provided information for use in sending read or write requests to the submission queue of the queue pair assigned to the VM or container for I/O access to the host physical memory or storage.

### Example 9

The method of example 8 may also include attaching a namespace to the queue pair to represent a disk drive to an operating system of the host computing platform and to provide access control to the at least portions of the host physical memory or storage. The method may also include providing the namespace to the VDEV for the VDEV to include the namespace when sending read or write requests to the submission queue.

### Example 10

The method of example 8 may also include configuring QoS or bandwidth settings for the queue pair for use in one or more arbitration schemes implemented at the controller to select read or write requests sent to the submission queue by the VDEV in comparison to other read or write requests in other submission queues maintained at the controller.

### Example 11

The method of example 10, the one or more arbitration schemes may include a round robin arbitration scheme or a weighted round robin arbitration scheme.

### Example 12

The method of example 8, the controller may operate according to a PCIe specification. For these examples, the PASID assigned to the queue pair may be a 20-bit prefix header to be included in read or write requests sent by the controller for I/O access to the host physical memory or storage.

### Example 13

The method of example 12, the controller may also operate according to a NVMe specification or a SAS specification.

### Example 14

The method of example 8, the method may be implemented by a hypervisor or VMM supported by a processor of the host computing platform.

### Example 15

The method of example 8, the host physical memory or storage may include volatile memory or non-volatile memory. For these examples, the volatile memory may include dynamic random access memory (DRAM) and the non-volatile memory may include 3-dimensional cross-point memory, memory that uses chalcogenide phase change material, multi-threshold level NAND flash memory, NOR flash memory, single or multi-level phase change memory (PCM), resistive memory, ovonic memory, nanowire memory, ferroelectric transistor random access memory (FeTRAM), magnetoresistive random access memory (MRAM) memory that incorporates memristor technology, or spin transfer torque MRAM (STT-MRAM).

### Example 16

An example at least one machine readable medium may include a plurality of instructions that in response to being executed by a system may cause the system to carry out a method according to any one of examples 10 to 15.

### Example 17

An example apparatus may include means for performing the methods of any one of examples 10 to 15.

### Example 18

An example at least one machine readable medium may include a plurality of instructions that in response to being executed by a system may cause the system to allocate a queue pair that includes a submission queue and a completion queue maintained at a controller for input/output (I/O) access to a host physical memory or storage for a host computing platform. The instructions may also cause the system to assign a PASID to the queue pair such that received read or write requests including the PASID are at least temporarily stored in the submission queue, the received read or write request for I/O access to the host physical memory or storage. The instructions may also cause the system to assign the queue pair to a VM or container hosted by the host computing platform. The instructions may also cause the system to enumerate a VDEV controlled by a guest driver of the VM or container, the VDEV provided information for use in sending read or write requests to the submission queue of the queue pair assigned to the VM or container for I/O access to the host physical memory or storage.

### Example 19

The at least one machine readable medium of example 18, comprising the instructions to further cause the system to attach a namespace to the queue pair to represent a disk drive to an operating system of the host computing platform and to provide access control to the at least portions of the host physical memory or storage. The instructions may also cause the system to provide the namespace to the VDEV for the VDEV to include the namespace when sending read or write requests to the submission queue.

### Example 20

The at least one machine readable medium of example 18, the instructions may further cause the system to configure QoS or bandwidth settings for the queue pair for use in one or more arbitration schemes implemented at the controller to select read or write requests sent to the submission queue by the VDEV in comparison to other read or write requests in other submission queues maintained at the controller.

### Example 21

The at least one machine readable medium of example 20, the one or more arbitration schemes may include a round robin or a weighted round robin arbitration scheme.

### Example 22

The at least one machine readable medium of example 18, the controller may operate according to a PCIe specification. For these examples, the PASID assigned to the queue pair is a 20-bit prefix header may be included in read or write requests sent by the controller for I/O access to the host physical memory or storage.

### Example 23

The at least one machine readable medium of example 22, the controller to may also operate according to a NVMe specification or a Serial Attached SCSI (SAS) specification.

### Example 24

The at least one machine readable medium of example 18, the system may be a hypervisor or VMM supported by a processor of the host computing platform.

### Example 25

The at least one machine readable medium of example 18, the host physical memory or storage may include volatile memory or non-volatile memory. For these examples, the volatile memory may include dynamic random access memory (DRAM) and the non-volatile memory may include 3-dimensional cross-point memory, memory that uses chalcogenide phase change material, multi-threshold level NAND flash memory, NOR flash memory, single or multi-level phase change memory (PCM), resistive memory, ovonic memory, nanowire memory, ferroelectric transistor random access memory (FeTRAM), magnetoresistive random access memory (MRAM) memory that incorporates memristor technology, or spin transfer torque MRAM (STT-MRAM).

### Example 26

An example apparatus may include circuitry at a controller for input/output (I/O) access to physical memory or storage for a host computing platform. The apparatus may also include receive logic for execution by the circuitry to receive a read or write request for I/O access to the physical memory or storage that includes a PASID and a GPA. The read or write request may have the PASID and the GPA received in a submission queue of a queue pair maintained at the controller. The queue pair may be assigned to the PASID and also assigned to a virtual machine or container hosted by the host computing platform. The apparatus may also include arbitration logic for execution by the circuitry to complete an arbitration scheme to select the read or write request in the submission queue from among one or more other read or write requests for I/O access to the physical memory or storage in one or more other submission queues maintained at the controller. The apparatus may also include send logic for execution by the circuitry to send the read or write request including the PASID and the GPA to a processor of the host computing platform. The processor may translate the GPA to an HPA and cause a direct memory access transaction to the physical memory or storage to complete the I/O access to the physical memory or storage.

### Example 27

The apparatus of example 26, the receive logic may receive a completion message from the processor indicating completion of the I/O access to the physical memory or storage. The apparatus may also include completion logic for execution by the circuitry to cause a read or write completion message to be included in a completion queue included with the submission queue to form the queue pair, the read or write completion message including the GPA.

### Example 28

The apparatus of example 27, the controller for I/O access to the physical memory or storage may operate according to a PCIe specification. For these examples, the controller may be coupled with the processor via a PCIe link.

### Example 29

The apparatus of example 28, the send logic to send the read or write request to the processor include the send logic to send a PCIe read or write TLP and the PASID is a 20-bit prefix header included with the PCIe read or write TLP. For these examples, the PCIe read or write TLP may include the PASID and the GPA may be to be sent to a PCIe root complex at the processor via the PCIe link.

### Example 30

The apparatus of example 28, the controller may also operate according to a NVMe specification or a SAS specification.

### Example 31

The apparatus of example 26 may also include namespace logic for execution by the circuitry to accept the read or write request received in the submission queue of the queue pair based on a namespace attached to the queue pair matching a namespace associated with the GPA included in the read or write request.

### Example 32

The apparatus of example 26, the arbitration scheme may include one or more of a round robin arbitration scheme or a weighted round robin arbitration scheme.

### Example 33

The apparatus of example 32, the weighted round robin arbitration scheme may be based, at least in part, on QoS or bandwidth settings for the queue pair, the PASID or the virtual machine or container assigned to the queue pair.

### Example 34

The apparatus of example 26, the processor may translate the GPA to the HPA using an IOMMU at the processor.

### Example 35

The apparatus of example 26, the physical memory or storage for the host computing platform may include volatile memory or non-volatile memory. For these examples, the volatile memory may include dynamic random access memory (DRAM) and the non-volatile memory may include 3-dimensional cross-point memory, memory that uses chalcogenide phase change material, multi-threshold level NAND flash memory, NOR flash memory, single or multi-level phase change memory (PCM), resistive memory, ovonic memory, nanowire memory, ferroelectric transistor random access memory (FeTRAM), magnetoresistive random access memory (MRAM) memory that incorporates memristor technology, or spin transfer torque MRAM (STT-MRAM).

### Example 36

An example method may include receiving, at a controller for input/output (I/O) access to physical memory or storage for a host computing platform, a read or write request for I/O access to the physical memory or storage that includes a PASID and a GPA. The read or write request may have the PASID and the GPA received in a submission queue of a queue pair maintained at the controller. The queue pair may be assigned to the PASID and also assigned to a virtual machine or container hosted by the host computing platform. The method may also include completing an arbitration scheme to select the read or write request in the submission queue from among one or more other read or write requests for I/O access to the physical memory or storage in one or more other submission queues maintained at the controller. The method may also include sending the read or write request including the PASID and the GPA to a processor of the host computing platform. The processor may translate the GPA to an HPA and cause a direct memory access transaction to the physical memory or storage to complete the I/O access to the physical memory or storage.

### Example 37

The method of example 36 may also include receiving a completion message from the processor indicating completion of the I/O access to the physical memory or storage. The method may also include causing a read or write completion message to be included in a completion queue included with the submission queue to form the queue pair, the read or write completion message including the GPA.

### Example 38

The method of example 39, the controller for I/O access to the physical memory or storage may operate according to a PCIe specification. For these examples, the controller may be coupled with the processor via a PCIe link.

### Example 39

The method of example 38, sending the read or write request to the processor may include sending a PCIe read or write TLP and the PASID is a 20-bit prefix header included with the PCIe read or write TLP. For these examples, the PCIe read or write TLP including the PASID and the GPA may be sent to a PCIe root complex at the processor via the PCIe link.

### Example 40

The method of example 39, the controller may also operate according to a NVMe specification or a SAS specification.

### Example 41

The method of example 35 may also include accepting the read or write request received in the submission queue of the queue pair based on a namespace attached to the queue pair matching a namespace associated with the GPA included in the read or write request.

### Example 42

The method of example 36, the arbitration scheme may include one or more of a round robin arbitration scheme or a weighted round robin arbitration scheme.

### Example 43

The method of example 42, the weighted round robin arbitration scheme may be based, at least in part, on QoS or bandwidth settings for the queue pair. The PASID or the virtual machine or container may be assigned to the queue pair.

### Example 44

The method of example 36, the processor may translate the GPA to the HPA using an IOMMU at the processor.

### Example 45

The method of example 36, the physical memory or storage for the host computing platform may include volatile memory or non-volatile memory. For these examples, the volatile memory may include dynamic random access memory (DRAM) and the non-volatile memory may include 3-dimensional cross-point memory, memory that uses chalcogenide phase change material, multi-threshold level NAND flash memory, NOR flash memory, single or multi-level phase change memory (PCM), resistive memory, ovonic memory, nanowire memory, ferroelectric transistor random access memory (FeTRAM), magnetoresistive random access memory (MRAM) memory that incorporates memristor technology, or spin transfer torque MRAM (STT-MRAM).

### Example 46

An example at least one machine readable medium may include a plurality of instructions that in response to being executed by a system may cause the system to carry out a method according to any one of examples 36 to 45.

### Example 47

An example apparatus may include means for performing the methods of any one of examples 36 to 45.

### Example 48

An example at least one machine readable medium may include a plurality of instructions that in response to being executed by a controller for input/output (I/O) access to at least a portion of physical memory or storage for a host computing platform may cause the controller to receive a read or write request for I/O access to the physical memory or storage that includes a PASID and a GPA, the read or write request having the PASID and the GPA received in a submission queue of a queue pair maintained at the controller. The queue pair may be assigned to the PASID and also assigned to a virtual machine or container hosted by the host computing platform. The instructions may also cause the controller to complete an arbitration scheme to select the read or write request in the submission queue from among one or more other read or write requests for I/O access to the physical memory or storage in one or more other submission queues maintained at the controller. The instructions may also cause the controller to send the read or write request including the PASID and the GPA to a processor of the host computing platform, the processor to translate the GPA to an HPA and cause a direct memory access transaction to the physical memory or storage to complete the I/O access to the physical memory or storage.

### Example 49

The at least one machine readable medium of example 48, the instructions may further cause the controller to receive a completion message from the processor indicating completion of the I/O access to the physical memory or storage. The instructions may also cause the controller to cause a read or write completion message to be included in a completion queue included with the submission queue to form the queue pair, the read or write completion message including the GPA.

### Example 50

The at least one machine readable medium of example 49, the controller may operate according to a PCIe specification. For these examples, the controller may be coupled with the processor via a PCIe link.

### Example 51

The at least one machine readable medium of example 50, the instructions to cause the controller to send the read or write request to the processor may include the controller to send a PCIe read or write TLP and the PASID is a 20-bit prefix header included with the PCIe read or write TLP, wherein the PCIe read or write TLP including the PASID and the GPA is sent to a PCIe root complex at the processor via the PCIe link.

### Example 52

The at least one machine readable medium of example 50, the controller to may also operate according to a NVMe specification or a SAS specification.

### Example 53

The at least one machine readable medium of example 48, the instructions may also cause the system to accept the read or write request received in the submission queue of the queue pair based on a namespace attached to the queue pair matching a namespace associated with the GPA included in the read or write request.

### Example 54

The at least one machine readable medium of example 48, the arbitration scheme may include one or more of a round robin arbitration scheme or a weighted round robin arbitration scheme.

### Example 55

The at least one machine readable medium of example 54, the weighted round robin arbitration scheme may be based, at least in part, on QoS or bandwidth settings for the queue pair, the PASID or the virtual machine or container assigned to the queue pair.

### Example 56

The at least one machine readable medium of example 48, the processor may translate the GPA to the HPA using an IOMMU at the processor.

### Example 57

The at least one machine readable medium of example 48, the physical memory or storage for the host computing platform may include volatile memory or non-volatile memory. For these examples, the volatile memory may include dynamic random access memory (DRAM) and the non-volatile memory may include 3-dimensional cross-point memory, memory that uses chalcogenide phase change material, multi-threshold level NAND flash memory, NOR flash memory, single or multi-level phase change memory (PCM), resistive memory, ovonic memory, nanowire memory, ferroelectric transistor random access memory (FeTRAM), magnetoresistive random access memory (MRAM) memory that incorporates memristor technology, or spin transfer torque MRAM (STT-MRAM).

### Example 58

An example apparatus may include circuitry at a processor for a host computing platform supporting one or more VMs or containers. The apparatus may also include receive logic for execution by the circuitry to receive a read or write request for input/output (I/O) access to physical memory or storage for the host computing platform, the read or write request received from a controller coupled with the processor and including a PASID and a GPA. The apparatus may also include translation logic for execution by the circuitry to translate the GPA to an HPA via use of an IOMMU. The apparatus may also include DMA logic for execution by the circuitry to cause a DMA transaction to the physical memory or storage using the HPA to complete the I/O access to the physical memory or storage. The apparatus may also include completion logic for execution by the circuitry to send a completion message to the controller indicating completion of the I/O access to the physical memory or storage.

### Example 59

The apparatus of example 58, the translation logic to translate the GPA via use of the IOMMU may include the IOMMU to utilize a DMA remapping table to determine the HPA based, at least in part, on the PASID included in the read or write request.

### Example 60

The apparatus of example 58, the DMA logic to cause the DMA transaction may include use of a DMA engine at the processor to read or write data to the physical memory or storage based on HPA.

### Example 61

The apparatus of example 60, the completion logic may send the completion message to the controller to indicate completion of the I/O access to the physical memory or storage responsive to receiving an indication from the DMA engine indicating the DMA transaction has been completed.

### Example 62

The apparatus of example 58, the controller for I/O access to the physical memory or storage may operate according to a PCIe specification. For these examples, the controller may be coupled with the processor via a PCIe link.

### Example 63

The apparatus of example 62, the receive logic to receive the read or write request may include the controller to send a PCIe read or write TLP and the PASID is a 20-bit prefix header included with the PCIe read or write TLP. For these examples, the PCIe read or write TLP may include the PASID and the GPA is to be sent to a PCIe root complex at the processor via the PCIe link.

### Example 64

The apparatus of example 63, the completion logic to send the completion message may include sending the completion message from the PCIe root complex in a PCIe read or write TLP completion message.

### Example 65

The apparatus of example 58, the physical memory or storage for the host computing platform may include volatile memory or non-volatile memory. For these examples, the volatile memory may include dynamic random access memory (DRAM) and the non-volatile memory may include 3-dimensional cross-point memory, memory that uses chalcogenide phase change material, multi-threshold level NAND flash memory, NOR flash memory, single or multi-level phase change memory (PCM), resistive memory, ovonic memory, nanowire memory, ferroelectric transistor random access memory (FeTRAM), magnetoresistive random access memory (MRAM) memory that incorporates memristor technology, or spin transfer torque MRAM (STT-MRAM).

### Example 66

An example method may include receiving, at a processor for a host computing platform supporting one or more VMs or containers, a read or write request for input/output (I/O) access to physical memory or storage for the host computing platform, the read or write request received from a controller coupled with the processor and including a PASID and a GPA. The method may also include translating the GPA to an HPA using an IOMMU. The method may also include causing a DMA transaction to the physical memory or storage using the HPA to complete the I/O access to the physical memory or storage. The method may also include sending a completion message to the controller indicating completion of the I/O access to the physical memory or storage.

### Example 67

The method of example 66, translating the GPA using the IOMMU may include the IOMMU utilizing a DMA remapping table to determine the HPA based, at least in part, on the PASID included in the read or write request.

### Example 68

The method of example 66, causing the DMA transaction may include using a DMA engine at the processor to read or write data to the physical memory or storage based on HPA.

### Example 69

The method of example 68 may include sending the completion message to the controller indicating completion of the I/O access to the physical memory or storage responsive to receiving an indication from the DMA engine indicating the DMA transaction has been completed.

### Example 70

The method of example 66, the controller for I/O access to the physical memory or storage may operate according to a PCIe specification. For these examples, the controller may be coupled with the processor via a PCIe link.

### Example 71

The method of example 70, receiving the read or write request may include the controller sending a PCIe read or write TLP and the PASID is a 20-bit prefix header included with the PCIe read or write TLP. For these examples, the PCIe read or write TLP may include the PASID and the GPA may be sent to a PCIe root complex at the processor via the PCIe link.

### Example 72

The method of example 71, sending the completion message may include sending the completion message from the PCIe root complex in a PCIe read or write TLP completion message.

### Example 73

The method of example 66, the physical memory or storage for the host computing platform may include volatile memory or non-volatile memory. For these examples, the volatile memory may include dynamic random access memory (DRAM) and the non-volatile memory may include 3-dimensional cross-point memory, memory that uses chalcogenide phase change material, multi-threshold level NAND flash memory, NOR flash memory, single or multi-level phase change memory (PCM), resistive memory, ovonic memory, nanowire memory, ferroelectric transistor random access memory (FeTRAM), magnetoresistive random access memory (MRAM) memory that incorporates memristor technology, or spin transfer torque MRAM (STT-MRAM).

### Example 74

An example at least one machine readable medium may include a plurality of instructions that in response to being executed by a system may cause the system to carry out a method according to any one of examples 66 to 73.

### Example 75

An example apparatus may include means for performing the methods of any one of examples 66 to 73.

### Example 76

At least one machine readable medium may include a plurality of instructions that in response to being executed by a system at a processor for a host computing platform supporting one or more VMs or containers may cause the system to receive a read or write request for input/output (I/O) access to physical memory or storage for the host computing platform, the read or write request received from a controller coupled with the processor and including a PASID and a GPA. The instructions may also cause the system to translate the GPA to an HPA using an IOMMU. The instructions may also cause the system to cause a DMA transaction to the physical memory or storage using the HPA to complete the I/O access to the physical memory or storage. The instructions may also cause the system to send a completion message to the controller indicating completion of the I/O access to the physical memory or storage.

### Example 77

The at least one machine readable medium of example 76, to translate the GPA using the IOMMU may include the IOMMU to utilize a DMA remapping table to determine the HPA based, at least in part, on the PASID included in the read or write request.

### Example 78

The at least one machine readable medium of example 76, to cause the DMA transaction may include use of a DMA engine at the processor to read or write data to the physical memory or storage based on HPA.

### Example 79

The at least one machine readable medium of example 78, the instructions may further cause the system to send the completion message to the controller indicating completion of the I/O access to the physical memory or storage responsive to receiving an indication from the DMA engine indicating the DMA transaction has been completed.

### Example 80

The at least one machine readable medium of example 79, the controller for I/O access to the physical memory or storage may operate according to a PCIe specification. For these examples, the controller may be coupled with the processor via a PCIe link.

### Example 81

The at least one machine readable medium of example 80, to receive the read or write request may include the controller to send a PCIe read or write TLP and the PASID is a 20-bit prefix header included with the PCIe read or write TLP. For these examples, the PCIe read or write TLP may include the PASID and the GPA is sent to a PCIe root complex at the processor via the PCIe link.

### Example 82

The at least one machine readable medium of example 81, to send the completion message may include to send the completion message from the PCIe root complex in a PCIe read or write TLP completion message.

### Example 83

The at least one machine readable medium of claim 76, the physical memory or storage for the host computing platform may include volatile memory or non-volatile memory. For these examples, the volatile memory may include dynamic random access memory (DRAM) and the non-volatile memory may include 3-dimensional cross-point memory, memory that uses chalcogenide phase change material, multi-threshold level NAND flash memory, NOR flash memory, single or multi-level phase change memory (PCM), resistive memory, ovonic memory, nanowire memory, ferroelectric transistor random access memory (FeTRAM), magnetoresistive random access memory (MRAM) memory that incorporates memristor technology, or spin transfer torque MRAM (STT-MRAM).

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. At least one machine readable medium comprising a plurality of instructions that in response to being executed by a system cause the system to:
allocate a queue pair that includes a submission queue and a completion queue maintained at a controller for input/output (I/O) access to a host physical memory or storage for a host computing platform;
assign a process address space identifier (PASID) to the queue pair such that received read or write requests including the PASID are at least temporarily stored in the submission queue, the received read or write request for I/O access to the host physical memory or storage;
assign the queue pair to a virtual machine (VM) or container hosted by the host computing platform; and
enumerate a virtual device (VDEV) controlled by a guest driver of the VM or container, the VDEV provided information for use in sending read or write requests to the submission queue of the queue pair assigned to the VM or container for I/O access to the host physical memory or storage.

2. The at least one machine readable medium of claim 1, comprising the instructions to further cause the system to:
attach a namespace to the queue pair to represent a disk drive to an operating system of the host computing platform and to provide access control to the at least portions of the host physical memory or storage; and
provide the namespace to the VDEV for the guest driver to include the namespace when sending read or write requests to the submission queue.

3. The at least one machine readable medium of claim 1, comprising the instructions to further cause the system to:
configure quality of service (QoS) or bandwidth settings for the queue pair for use in one or more arbitration schemes implemented at the controller to select read or write requests sent to the submission queue by the VDEV in comparison to other read or write requests in other submission queues maintained at the controller.

4. The at least one machine readable medium of claim 3, comprising the one or more arbitration schemes include a round robin or a weighted round robin arbitration scheme.

5. The at least one machine readable medium of claim 1, comprising the controller to operate according to a Peripheral Component Interconnect Express (PCIe) specification, the PASID assigned to the queue pair is a 20-bit prefix header to be included in read or write requests sent by the controller for I/O access to the host physical memory or storage.

6. The at least one machine readable medium of claim 5, comprising the controller to also operate according to a Non-Volatile Memory Express (NVMe) specification or a Serial Attached SCSI (SAS) specification.

7. The at least one machine readable medium of claim 1, the system comprising a hypervisor or virtual machine manager (VMM) supported by a processor of the host computing platform.

8. The at least one machine readable medium of claim 1, comprising the host physical memory or storage including volatile memory or non-volatile memory, wherein the volatile memory includes dynamic random access memory (DRAM) and the non-volatile memory includes 3-dimensional cross-point memory, memory that uses chalcogenide phase change material, multi-threshold level NAND flash memory, NOR flash memory, single or multi-level phase change memory (PCM), resistive memory, ovonic memory, nanowire memory, ferroelectric transistor random access memory (FeTRAM), magnetoresistive random access memory (MRAM) memory that incorporates memristor technology, or spin transfer torque MRAM (STT-MRAM).

9. An apparatus comprising:
circuitry at a controller for input/output (I/O) access to physical memory or storage for a host computing platform;
receive logic for execution by the circuitry to receive a read or write request for I/O access to the physical memory or storage that includes a process address space identifier (PASID) and a guest physical address (GPA), the read or write request having the PASID and the GPA received in a submission queue of a queue pair maintained at the controller, the queue pair assigned to the PASID and also assigned to a virtual machine or container hosted by the host computing platform;
arbitration logic for execution by the circuitry to complete an arbitration scheme to select the read or write request in the submission queue from among one or more other read or write requests for I/O access to the physical memory or storage in one or more other submission queues maintained at the controller;
send logic for execution by the circuitry to send the read or write request including the PASID and the GPA to a processor of the host computing platform, the processor to translate the GPA to a host physical address (HPA) and cause a direct memory access transaction to the physical memory or storage to complete the I/O access to the physical memory or storage.

10. The apparatus of claim 9, comprising:
the receive logic to receive a completion message from the processor indicating completion of the I/O access to the physical memory or storage; and
completion logic for execution by the circuitry to cause a read or write completion message to be included in a completion queue included with the submission queue to form the queue pair, the read or write completion message including the GPA.

11. The apparatus of claim 10, comprising the controller for I/O access to the physical memory or storage to operate according to a Peripheral Component Interconnect Express (PCIe) specification, the controller coupled with the processor via a PCIe link.

12. The apparatus of claim 11, the send logic to send the read or write request to the processor comprises the send logic to send a PCIe read or write transaction layer packet (TLP) and the PASID is a 20-bit prefix header included with the PCIe read or write TLP, wherein the PCIe read or write TLP to include the PASID and the GPA is to be sent to a PCIe root complex at the processor via the PCIe link.

13. The apparatus of claim 11, comprising the controller to also operate according to a Non-Volatile Memory Express (NVMe) specification or a Serial Attached SCSI (SAS) specification.

14. The apparatus of claim 9, further comprising:
namespace logic for execution by the circuitry to accept the read or write request received in the submission queue of the queue pair based on a namespace attached to the queue pair matching a namespace associated with the GPA included in the read or write request.

15. The apparatus of claim 9, comprising the arbitration scheme to include one or more of a round robin arbitration scheme or a weighted round robin arbitration scheme.

16. The apparatus of claim 15, comprising the weighted round robin arbitration scheme based, at least in part, on quality of service (QoS) or bandwidth settings for the queue pair, the PASID or the virtual machine or container assigned to the queue pair.

17. The apparatus of claim 9, comprising the processor to translate the GPA to the HPA using an input/output memory management unit (IOMMU) at the processor.

18. The apparatus of claim 9, comprising the physical memory or storage for the host computing platform including volatile memory or non-volatile memory, wherein the volatile memory includes dynamic random access memory (DRAM) and the non-volatile memory includes 3-dimensional cross-point memory, memory that uses chalcogenide phase change material, multi-threshold level NAND flash memory, NOR flash memory, single or multi-level phase change memory (PCM), resistive memory, ovonic memory, nanowire memory, ferroelectric transistor random access memory (FeTRAM), magnetoresistive random access memory (MRAM) memory that incorporates memristor technology, or spin transfer torque MRAM (STT-MRAM).

19. A method comprising:
receiving, at a controller for input/output (I/O) access to physical memory or storage for a host computing platform, a read or write request for I/O access to the physical memory or storage that includes a process address space identifier (PASID) and a guest physical address (GPA), the read or write request having the PASID and the GPA received in a submission queue of a queue pair maintained at the controller, the queue pair assigned to the PASID and also assigned to a virtual machine or container hosted by the host computing platform;
completing an arbitration scheme to select the read or write request in the submission queue from among one or more other read or write requests for I/O access to the physical memory or storage in one or more other submission queues maintained at the controller; and
sending the read or write request including the PASID and the GPA to a processor of the host computing platform, the processor to translate the GPA to a host physical address (HPA) and cause a direct memory access transaction to the physical memory or storage to complete the I/O access to the physical memory or storage.

20. The method of claim 19, comprising:
receiving a completion message from the processor indicating completion of the I/O access to the physical memory or storage; and
causing a read or write completion message to be included in a completion queue included with the submission queue to form the queue pair, the read or write completion message including the GPA.

21. The method of claim 20, comprising the controller for I/O access to the physical memory or storage to operate according to a Peripheral Component Interconnect Express (PCIe) specification, the controller coupled with the processor via a PCIe link.

22. The method of claim 21, sending the read or write request to the processor comprises sending a PCIe read or write transaction layer packet (TLP) and the PASID is a 20-bit prefix header included with the PCIe read or write TLP, wherein the PCIe read or write TLP including the PASID and the GPA is sent to a PCIe root complex at the processor via the PCIe link.

23. An apparatus comprising:
circuitry at a processor for a host computing platform supporting one or more virtual machine (VMs) containers;
receive logic for execution by the circuitry to receive a read or write request for input/output (I/O) access to physical memory or storage for the host computing platform, the read or write request received from a controller coupled with the processor and including a process address space identifier (PASID) and a guest physical address (GPA);
translation logic for execution by the circuitry to translate the GPA to a host physical address (HPA) via use of an input/output memory management unit (IOMMU);
direct memory access (DMA) logic for execution by the circuitry to cause a DMA transaction to the physical memory or storage using the HPA to complete the I/O access to the physical memory or storage; and
completion logic for execution by the circuitry to send a completion message to the controller indicating completion of the I/O access to the physical memory or storage.

24. The apparatus of claim 23, the translation logic to translate the GPA via use of the IOMMU comprises the IOMMU to utilize a DMA remapping table to determine the HPA based, at least in part, on the PASID included in the read or write request.

25. The apparatus of claim 23, the DMA logic to cause the DMA transaction comprises use of a DMA engine at the processor to read or write data to the physical memory or storage based on HPA.

26. The apparatus of claim 25, comprising the completion logic to send the completion message to the controller to indicate completion of the I/O access to the physical memory or storage responsive to receiving an indication from the DMA engine indicating the DMA transaction has been completed.

27. The apparatus of claim 23, comprising the controller for I/O access to the physical memory or storage to operate according to a Peripheral Component Interconnect Express (PCIe) specification, the controller coupled with the processor via a PCIe link.

28. The apparatus of claim 27, the receive logic to receive the read or write request comprises the controller to send a PCIe read or write transaction layer packet (TLP) and the PASID is a 20-bit prefix header included with the PCIe read or write TLP, wherein the PCIe read or write TLP including the PASID and the GPA is to be sent to a PCIe root complex at the processor via the PCIe link.

29. The apparatus of claim 28, the completion logic to send the completion message comprises to send the completion message from the PCIe root complex in a PCIe read or write TLP completion message.

30. The apparatus of claim 23, comprising the physical memory or storage for the host computing platform including volatile memory or non-volatile memory, wherein the volatile memory includes dynamic random access memory (DRAM) and the non-volatile memory includes 3-dimensional cross-point memory, memory that uses chalcogenide phase change material, multi-threshold level NAND flash memory, NOR flash memory, single or multi-level phase change memory (PCM), resistive memory, ovonic memory, nanowire memory, ferroelectric transistor random access memory (FeTRAM), magnetoresistive random access memory (MRAM) memory that incorporates memristor technology, or spin transfer torque MRAM (STT-MRAM).
